(19) United States
(12) Patent Application Publication
(10) Pub. No.: US 2001/0032265 A1
(43) Pub. Date: Oct. 18, 2001

(54) Method of communication control and system thereof

(75) Inventor: Masashi Tanaka, Tokyo (JP)

Correspondence Address: David A. Blumenthal, FOLEY & LARDNER, Washington Harbour, 3000 K Street, N.W., Suite 500, Washington, DC, 20007-5109, US

(73) Assignee: NEC CORPORATION.

(21) Appl. No.: 09/798,989

(22) Filed: Mar. 6, 2001

(30) Foreign Application Priority Data
Apr. 13, 2000 (JP) 2000-111429

(51) Int. Cl. G06F 15/16

(52) U.S. Cl. 709/227; 709/230

(57) ABSTRACT

A method of communication control, a communication control system, and a recording medium used in the method or system are provided. The method has the steps of recognizing service type information that specifies a type of communication service in a packet with a predetermined protocol; obtaining parameter information for establishing connection, which is previously coordinate to the recognized service type information; and sending a SETUP message that is generated using the obtained parameter information. The communication-control system performs such a method. The recording medium stores a program responsible for executing the method. Accordingly, the present invention ensures the communication band and communication quality on the basis of the types of service and traffic in the TCP/IP application or the UDP/IP application over the Internet.

### CROSS REFERENCE TO RELATED APPLICATIONS

The present invention claims priority from Japanese Patent Application No. 2000-111429 filed Apr. 13, 2000, the contents of which are incorporated herein by reference.

### BACKGROUND OF THE INVENTION

1. Field of the Invention

The present invention relates to improvements on the technologies for communication control.

2. Description of Related Art

Data communications services using the Internet are increasing recently. In the Internet, Internet Protocol (IP) is defined for the data communications. For a network layer of the Internet Protocol, RFC (Request for Comment) 791 “Internet Protocol” (issued on September 1981, which may be revised or extended) (hereinafter, referred to as “IPv4”); and RFC 2460 “Internet Protocol, Version 6th (IPv6)” (issued on December 1998, in Internet Engineering Task Force (IETF), which may be revised or extended) (hereinafter, referred to as “IPv6”) are referenced. For a transport layer of the Internet protocol, on the other hand, RFC793 “Transmission Control Protocol ” (issued on September 1981, which may be revised or extended) (hereinafter, referred to as “TCP”) and RFC768 “User Datagram Protocol” (issued on August 1980, which may be revised or extended) (hereinafter, referred to as “UCP”) are referenced.

Electronic mails (e-mails) have been provided as main service data of the Internet and transmitted and received over a communications network of the Internet. In recent years, the service data to be provided through the Internet comes to include various kinds of digital contents such as e-mail with document data, a set of interlinked documents in a hypertext system (i.e., Web data), sound data, voice data, still picture data, moving picture data, and music data. These data are collectively called “Internet services” to be supplied through the Internet. These services may be available by any application using TCP/IP or UDP/IP as a standard protocol for data transmission over networks. The amount of data to be processed by the TCP or UDP/IP application becomes extensively large.

On the other hand, another network has been constructed using a communications system of the Asynchronous Transfer Mode (ATM), which is capable of high-speed and reliable network communications for transmitting massive multi-media information in real time with reliability. In the AMT communications system, transmitting/receiving data is broken into packets called “ATM cells” with a short fixed-length each and then asynchronously transmitted through the network. The exchange of information over the ATM network, i.e., data communications, may be performed using the Permanent Virtual Channel (PVC) connection or the Switched Virtual Channel (SVC) connection.

The PVC connection is established when a subscriber informs communication band and quality to be used for the data communications to a provider of the ATM network or the ATM-subscriber network when the subscriber makes a contract with the provider. The subscriber will be able to use the PVC connection for the data communications before canceling or terminating the contract with the provider.

On the other hand, the SVC connection is established when a subscriber sends an ATM UNI signaling message, especially a setup message with the entry of information of communication band and quality to be used when the subscriber using a TCP or UDP/IP application requires a transmission line for the data communications. In this case, the ATM UNI signaling message is based on the ATM UNI signaling procedure (hereinafter, also referred to as “ATM UNI signaling”) defined in the ATM Forum Technical Committee User Network Interface (UNI) Specification Version 3.1 (September 1994) (hereinafter, referred to as “UNI3.1”) or the ATM Forum Technical Committee ATM User-Network Interface (UNI) Signaling Specification Version 4.0 (July 1996) (hereinafter, referred to as “UNI4.0”).

For performing the data communications, as need arises, the SVC connection is established to the ATM network or the ATM subscriber network. The network comprises a plurality of ATM-switching equipments and subscriber terminals on which the TCP or UDP/IP applications are operated. On the other hand, there is no need to perform the data communications, an establishment/release control of the SVC connection is performed using the ATM signaling that executes the communication control for releasing the SVC connection and so on. Therefore, it allows the improvements in the convenience and the cost efficiency of the subscriber terminal on which the TCP or UDP/IP application for the communications of multimedia information. In addition, it allows the improvements in the flexibility, the effective use of resources in the communication band, and so on in the ATM network or the ATM subscriber network.

Conventionally, several technologies have been proposed for transmitting and receiving the predetermined information using the SVC connection in the ATM network for the purpose of realizing the communications of multimedia information with the high-speed and high-reliability, where digital contents are provided a unit of information named as an IP packet prepared by the above IPv4 or IPv6. Thus, the digital contents including e-mails, Web data, voice data, still and moving picture data, and music data can be transmitted as a whole from one device to another on the network.

Among those basic technologies, for example, RFC1483 “Multiprotocol Encapsulation over ATM Adaptation Layer 5” (July 1993) and RFC1577 “Classical IP and ARP over ATM” (hereinafter, referred to as “IPoA”) are well known in the art. The RFC 1483 is a technology for the transmission and reception of data by mapping the TCP/IP or UDP/IP packet on the ATM Adaptation Layer type 5 that is standardized in the ITU-T Recommendation I. 363. 5 (August 1996). The RFC 1577 is the technology for performing the communications of IP packet using the ATM network as one of logic subnets and the technology of Address Resolution Protocol (ATM ARP) that resolves the IP and ATM addresses in the logic subnet.

That is, the PFC 1483 defines the requirements of data communications system on the precondition that the PVC or SVC connection has already established for performing the data communications in the ATM network. In addition, the RFC 1577 defines the requirements of the process to resolve the IP address and the ATM address using the ATM ARP functions before the use of the ATM UNI signaling for establishing the SVC connection of the data communications in the ATM network.

The technology of controlling the SVC connection for the IP packet communications with reference to both RFC 1483 and RFC 1577, i.e., the technology regarding to how to utilize the ATM UNI signaling, has been proposed in RFC 1755 “ATM Signaling Support for IP over ATM” (February 1995), RFC 2331 “ATM Signaling support for IP over ATM-UNI Signaling 4.0 Update” (April 1998), and RFC 2381 “Interoperation of Controlled-Load Service and Guaranteed Service with ATM” (August 1998).

The RFC 1755 is a traffic service with best-efforts in communications qualities (hereinafter, also referred to “Best Effort”), which establishes the SVC connection for IP packet communications as ATM service of an Unspecified Bit Rate (UBR) by the use of ATM UNI signaling based on UNI 3.1. The RFC 2331 establishes the SVC connection for IP packet communications as ATM service of Constant Bit Rate (CBR), Real-Time Variable Bit Rate (rt-VBR), Non-Real Time VBR (nrt-VBR), Available Bit Rate (ABR), and UBR by the use of ATM UNI signaling based on UNI 4.0. Compatibility between each of the service items: CBR, rt-VBR, nrt-VBR, ABR, and UBR and the communication quality information is described in Appendix C of the RFC 2331. An communication quality can be available if the specified compatibility is used, so that the communication quality of the device may be depended on its packaging condition.

For mapping the service that uses IPv4 and IPv6on the ATM network, the RFC 2381 defines the utilization of RCF 2205 “Resource Reservation Protocol (RSVP) Version 1, Functional Specification” (September, 1997) and the ATM UNI signaling. The RFC 2205 is a middleware protocol technology using UDP/IP for controlling the TCP/IP or UDP/IP connection in which the communication band and the communication quality of the IP packet communications are ensured. Thus, the RFC 2205 has been inherently unrelated to the ATM. Recently, for executing the RSVP on the ATM network, there are provided RFCs of IETF such as RFC 2379 “RSVP over ATM Implementation Guidelines” (August 1998), RFC 2380 “RSVP over ATM Implementation Requirements” (August 1998), and RFC 2382 “A Framework for Integrated Services and RSVP over ATM” (August 1998).

In summary, each of the conventional technologies described above establishes the SVC connection to the ATM network using the ATM UNI signaling for the transmission and reception of data mapped on the IP packet.

According to the above description concerned about the various kinds of the conventional technologies, there are several problems as described below. The first problem is that the SVC connection established for the data communications of IP packet constructed by the Internet protocol does not have the desired communication band and the communication quality expected by the TCP or UDP/IP application on an application layer that utilizes the TCP or UDP layer that is hierarchically higher than the IP layer provided as a network layer due to the following reasons.

RFC 1755, PFC 2331, and RFC 2381 define the process of constructing a SETUP message of the ATM UNI signaling for mapping the IP packet on the SVC connection of the ATM network. In this case, however, they do not define a SETUP message of the ATM UNI signaling for control the SVC connection having the communication band and communication quality to be fit the service (e.g., e-mail, Web data, voice, still and movie picture, and music data) of the TCP or UDP/IP application at a high-end. In the RFC 2331, all of the ATM services are provided but the services of the TCP or UDP/IP application at a high-end are not recognized. Therefore, there is a possibility of causing the mismatch between the expecting communication band or the expecting communication quality and the actually established communication band or the actually established communication quality. That is, the SETUP message of the ATM UNI signaling is constructed without consideration given to the service being controlled by the TCP or UDP/IP application.

The second problem is that one SVC connection is established per one IP address so that data communications of a plurality of TCP or UDP/I applications that provide services using the TCP or UDP layer hierarchically higher than the IP layer (i.e., network layer) are integrated on one SVC connection and shared. The reason is that the RFC 1577 utilizes the ATM-ARP features designed to establish one SVC connection per one IP address. In addition, there is another reason in which the RFC 1577 recognizes the ATM network as one logical subnet to be designed to establish one SVC connection per one IP address. For an additional reason, furthermore, there is the conventional management system in which IP address, ATM address, and SVC connection are provided at the ratio of 1:1:1.

The third problem is that the traffic type of the SVC connection to be established becomes the Best Effort type as described above. The reason is that communication qualities of all SVC connections become the Best Effort type when it is based on the RFC 1755 IPoA.

The fourth problem is that the demands on communication band and the communication quality of the SVC connection to be established becomes poor or excess with respect to the ATM network. Thus, the convenience and economic cost of the subscriber terminal on which TCP or UDP/IP application are decreased, causing difficulties in the effective use of resources such as communication bands and in the flexibility of the ATM network. The reason is that in the prior art technology the SETUP message of the ATM UNI signaling is constructed with reference to AtmTD IE, BBcap IE, and QoS IE information previously embodied in the device. Therefore, there is a possibility that it is not an establishing request of the SVC connection capable of providing the communication band and the communication quality that adapt to the conditions in which the ATM network and the ATM subscriber network is in operation, that is, the condition of lacking in the resources of the ATM network, and the condition of having enough resources.

It is, accordingly, an object of the present invention to overcome the disadvantages in the prior art described above by providing a method of communication control, a communication-control system, and a recording medium, which ensure the communication band and communication quality on the basis of the types of service and traffic in the TCP/IP application or the UDP/IP application.

In addition, another object of the present invention is to provide a method of communication control, a communication-control system, and a recording medium, which allow the improvements in the convenience and the cost efficiency of the subscriber terminal on which the TCP or UDP/IP application for the communications of multimedia information, and also allow the improvements in the flexibility, the effective use of resources in the communication band, and so on in the ATM network or the ATM subscriber network.

In a first aspect of the present invention, for accomplishing the foregoing objects, there is provided a method for communication control, comprising the steps of: recognizing service type information that specifies a type of communication service in a packet with a predetermined protocol; obtaining parameter information for establishing connection, which is previously coordinate to the recognized service type information; and sending a SETUP message that is generated using the obtained parameter information.

According to the first aspect of the present invention, therefore, the connection can be established by generating the SETUP message using parameter information based on the service type and sending the SETUP message.

Here, the determined protocol may be TCP or UDP, and the service type information may be a terminal port number in a TCP header or UDP header. In this case, therefore, the connection can be established by generating the SETUP message using parameter information based on the service type defined by the terminal port number with respect to the TCP or UDP application and sending the SETUP message.

In a second aspect of the present invention, there is provided a method for communication control, comprising the steps of: recognizing traffic type information that specifies a traffic type in a packet with a predetermined protocol; obtaining parameter information for establishing connection, which is previously coordinate to the recognized service type information; and sending a SETUP message that is generated using the obtained parameter information.

In this aspect of the present invention, therefore, the connection can be established by generating the SETUP message using parameter information based on the traffic type.

The predetermined protocol may be IP, and the traffic type information may be a service type or a traffic type in the IP header. In this case, therefore, the connection can be established by generating the SETUP message using parameter information based on the traffic type defined by the service type or the traffic type with respect to the IP application and sending the SETUP message.

In a third aspect of the present invention, there is provided a communication control system, comprising: means for recognizing service type information that specifies a type of communication service in a packet with a predetermined protocol; means for obtaining parameter information that corresponds to the recognized service type information with reference to a table that defines a coordination between each service type information and a parameter information for establishing a connection; and means for sending a SETUP message that is generated using the obtained parameter information.

In this aspect of the present invention, therefore, the connection can be established by generating the SETUP message using parameter information based on the service type. Then, the SETUP message is transmitted.

The determined protocol may be TCP or UDP; and the service type information may be a terminal port number in a TCP header or UDP header. In this case, therefore, the connection can be established by generating the SETUP message using parameter information based on the service type defined by the terminal port number with respect to the TCP or UDP application and sending the SETUP message.

The table may be stored in a network management device external to the communication control system control, and parameter information defined in the table may be obtained by making an access to the network management device. In this case, therefore, the network management device is easily perform an automatic update of the contents of the table as the parameter information defined by the table is obtained by making an access to the network management device.

In a fourth aspect of the present invention, there is provided a communication control system, comprising: means for recognizing traffic type information that specifies a type of traffic in a packet with a predetermined protocol; means for obtaining parameter information that corresponds to the recognized traffic type information with reference to a table that defines a coordination between each traffic type information and a parameter information for establishing a connection; and means for sending a SETUP message that is generated using the obtained parameter information.

In this aspect of the present invention, therefore, the connection can be established by generating the SETUP message using parameter information based on the traffic type and sending the SETUP message.

The determined protocol may be an IP; and the communication quality information may be a service type or a traffic type in an IP header. In this case, therefore, the connection can be established by generating the SETUP message using parameter information based on the service type defined by the terminal port number with respect to the TCP or UDP application and sending the SETUP message.

The table may be stored in a network management device external to the communication control system control, and parameter information defined in the table may be obtained by making an access to the network management device. In this case, therefore, the network management device is easily perform an automatic update of the contents of the table as the parameter information defined by the table is obtained by making an access to the network management device.

In a fifth aspect of the present invention, there is provided a recording medium that stores a computer-readable communication control program for performing a communication control, wherein the communication control program is capable of executing the process comprising the steps of: recognizing service type information that specifies a type of communication service in a packet with a predetermined protocol; obtaining parameter information for establishing connection, which is previously coordinate to the recognized service type information; and sending a SETUP message that is generated using the obtained parameter information.

In a sixth aspect of the present invention, there is provided a recording medium that stores a computer-readable communication control program for performing a communication control, wherein the communication control program is capable of executing the process comprising the steps of: recognizing traffic type information that specifies a traffic type in a packet with a predetermined protocol; obtaining parameter information for establishing connection, which is previously coordinate to the recognized service type information; and sending a SETUP message that is generated using the obtained parameter information.

The recording medium of the fifth or sixth aspect of the present invention may be selected from semiconductor recording media such as ROM and semiconductor IC, optical recording media such as DVD-ROM and CD-ROM, and magnetic recording media such as flexible disk, and magnetic optical recording media such as MO.

In a seventh aspect of the present invention, there is provided a method for communication control, comprising the steps of: recognizing “Type of Service” as a traffic type when a predetermined protocol is IPv4 or recognizing “Traffic Class” as a traffic type when a predetermined protocol is IPv6; recognizing a port number of TCP packet; grasping information elements of SETUP message corresponding to the traffic type/the port number; and sending the SETUP message to be generated using the grasped information elements.

In this aspect of the present invention, therefore, the SETUP message can be generated using information elements based on the traffic type and the port number.

### SUMMARY OF THE INVENTION

It is, accordingly, an object of the present invention to overcome the disadvantages in the prior art described above by providing a method of communication control, a communication-control system, and a recording medium, which ensure the communication band and communication quality on the basis of the types of service and traffic in the TCP/IP application or the UDP/IP application.

In addition, another object of the present invention is to provide a method of communication control, a communication-control system, and a recording medium, which allow the improvements in the convenience and the cost efficiency of the subscriber terminal on which the TCP or UDP/IP application for the communications of multimedia information, and also allow the improvements in the flexibility, the effective use of resources in the communication band, and so on in the ATM network or the ATM subscriber network.

In a first aspect of the present invention, for accomplishing the foregoing objects, there is provided a method for communication control, comprising the steps of: recognizing service type information that specifies a type of communication service in a packet with a predetermined protocol; obtaining parameter information for establishing connection, which is previously coordinate to the recognized service type information; and sending a SETUP message that is generated using the obtained parameter information.

According to the first aspect of the present invention, therefore, the connection can be established by generating the SETUP message using parameter information based on the service type and sending the SETUP message.

Here, the determined protocol may be TCP or UDP, and the service type information may be a terminal port number in a TCP header or UDP header. In this case, therefore, the connection can be established by generating the SETUP message using parameter information based on the service type defined by the terminal port number with respect to the TCP or UDP application and sending the SETUP message.

In a second aspect of the present invention, there is provided a method for communication control, comprising the steps of: recognizing traffic type information that specifies a traffic type in a packet with a predetermined protocol; obtaining parameter information for establishing connection, which is previously coordinate to the recognized service type information; and sending a SETUP message that is generated using the obtained parameter information.

In this aspect of the present invention, therefore, the connection can be established by generating the SETUP message using parameter information based on the traffic type.

The predetermined protocol may be IP, and the traffic type information may be a service type or a traffic type in the IP header. In this case, therefore, the connection can be established by generating the SETUP message using parameter information based on the traffic type defined by the service type or the traffic type with respect to the IP application and sending the SETUP message.

In a third aspect of the present invention, there is provided a communication control system, comprising: means for recognizing service type information that specifies a type of communication service in a packet with a predetermined protocol; means for obtaining parameter information that corresponds to the recognized service type information with reference to a table that defines a coordination between each service type information and a parameter information for establishing a connection; and means for sending a SETUP message that is generated using the obtained parameter information.

In this aspect of the present invention, therefore, the connection can be established by generating the SETUP message using parameter information based on the service type. Then, the SETUP message is transmitted.

The determined protocol may be TCP or UDP; and the service type information may be a terminal port number in a TCP header or UDP header. In this case, therefore, the connection can be established by generating the SETUP message using parameter information based on the service type defined by the terminal port number with respect to the TCP or UDP application and sending the SETUP message.

The table may be stored in a network management device external to the communication control system control, and parameter information defined in the table may be obtained by making an access to the network management device. In this case, therefore, the network management device is easily perform an automatic update of the contents of the table as the parameter information defined by the table is obtained by making an access to the network management device.

In a fourth aspect of the present invention, there is provided a communication control system, comprising: means for recognizing traffic type information that specifies a type of traffic in a packet with a predetermined protocol; means for obtaining parameter information that corresponds to the recognized traffic type information with reference to a table that defines a coordination between each traffic type information and a parameter information for establishing a connection; and means for sending a SETUP message that is generated using the obtained parameter information.

In this aspect of the present invention, therefore, the connection can be established by generating the SETUP message using parameter information based on the traffic type and sending the SETUP message.

The determined protocol may be an IP; and the communication quality information may be a service type or a traffic type in an IP header. In this case, therefore, the connection can be established by generating the SETUP message using parameter information based on the service type defined by the terminal port number with respect to the TCP or UDP application and sending the SETUP message.

The table may be stored in a network management device external to the communication control system control, and parameter information defined in the table may be obtained by making an access to the network management device. In this case, therefore, the network management device is easily perform an automatic update of the contents of the table as the parameter information defined by the table is obtained by making an access to the network management device.

In a fifth aspect of the present invention, there is provided a recording medium that stores a computer-readable communication control program for performing a communication control, wherein the communication control program is capable of executing the process comprising the steps of: recognizing service type information that specifies a type of communication service in a packet with a predetermined protocol; obtaining parameter information for establishing connection, which is previously coordinate to the recognized service type information; and sending a SETUP message that is generated using the obtained parameter information.

In a sixth aspect of the present invention, there is provided a recording medium that stores a computer-readable communication control program for performing a communication control, wherein the communication control program is capable of executing the process comprising the steps of: recognizing traffic type information that specifies a traffic type in a packet with a predetermined protocol; obtaining parameter information for establishing connection, which is previously coordinate to the recognized service type information; and sending a SETUP message that is generated using the obtained parameter information.

The recording medium of the fifth or sixth aspect of the present invention may be selected from semiconductor recording media such as ROM and semiconductor IC, optical recording media such as DVD-ROM and CD-ROM, and magnetic recording media such as flexible disk, and magnetic optical recording media such as MO.

In a seventh aspect of the present invention, there is provided a method for communication control, comprising the steps of: recognizing “Type of Service” as a traffic type when a predetermined protocol is IPv4 or recognizing “Traffic Class” as a traffic type when a predetermined protocol is IPv6; recognizing a port number of TCP packet; grasping information elements of SETUP message corresponding to the traffic type/the port number; and sending the SETUP message to be generated using the grasped information elements.

In this aspect of the present invention, therefore, the SETUP message can be generated using information elements based on the traffic type and the port number.

### BRIEF DESCRIPTION OF THE DRAWINGS

Specific embodiments of the present invention will now be described, by way of example only, with reference to the accompanying of drawings in which:

FIG. 1A, FIG. 1B, and FIG. 1C are diagrams for illustrating the prior art technologies, where FIG. 1A is a table in which destination IP addresses and destination ATM addresses are listed, FIG. 1B is a table in which information elements and the corresponding parameters are listed, and FIG. 1C is a schematic diagram of SVC-IP-TCP/UDP-connection;

FIG. 2 is a schematic diagram that illustrates the outline of present invention;

FIG. 3 is a block diagram that illustrates the first preferred embodiment of the present invention;

FIG. 4 is a schematic diagram that illustrates the TCP packet configuration;

FIG. 5 is a schematic diagram that illustrates the UDP packet configuration;

FIG. 6 is a schematic diagram that illustrates the IPv4 packet configuration;

FIG. 7 is a schematic diagram that illustrates the IPv6packet configuration;

FIG. 8 is a schematic diagram that illustrates the IP packet configuration;

FIG. 9 is a flow chart that illustrates the operation of the first preferred embodiment of the present invention;

FIG. 10 is an explanation diagram for illustrating a table that defines traffic types in accordance with the first preferred embodiment of the present invention;

FIG. 11 is an explanation diagram for illustrating a table that defines service types in accordance with the first preferred embodiment of the present invention;

FIG. 12 is an explanation diagram for illustrating a connection management table in accordance with the first preferred embodiment of the present invention;

FIG. 13 is an explanation diagram for illustrating the SETUP message;

FIG. 14 is a block diagram that illustrates the second preferred embodiment of the present invention;

FIG. 15 is a block diagram that illustrates the third preferred embodiment of the present invention;

FIG. 16 is a flow chart that illustrates the operation of the third preferred embodiment of the present invention;

FIG. 17 is an explanation diagram for illustrating the configuration of the Broadband High Layer Information IE constructed by the communication control system in accordance with the third preferred embodiment of the present invention;

FIG. 18 is an explanation diagram for illustrating the SETUP message;

FIG. 19 is a block diagram that illustrates another example of the third preferred embodiment of the present invention;

FIG. 20 is a flow chart that illustrates the operation of another example of the third preferred embodiment of the present invention;

FIG. 21 is a block diagram that illustrates of the fourth preferred embodiment of the present invention;

FIG. 22 is a flow chart that illustrates the operation of the fourth preferred embodiment of the present invention;

FIG. 23 is a block diagram that illustrates of the fifth preferred embodiment of the present invention;

FIG. 24 is a block diagram that illustrates of the sixth preferred embodiment of the present invention;

FIG. 25 is a flow chart that illustrates the operation of the sixth preferred embodiment of the present invention;

FIG. 26 is a schematic diagram that illustrates the logic configuration of IP over ATM connection;

FIG. 27 is a schematic diagram that illustrates the first concrete example;

FIG. 28 is a schematic diagram that illustrates the second concrete example; and

FIG. 29 is a schematic diagram that illustrates the third concrete example.

### DETAILED DESCRIPTION OF THE PREFERRED EMBODIMENTS

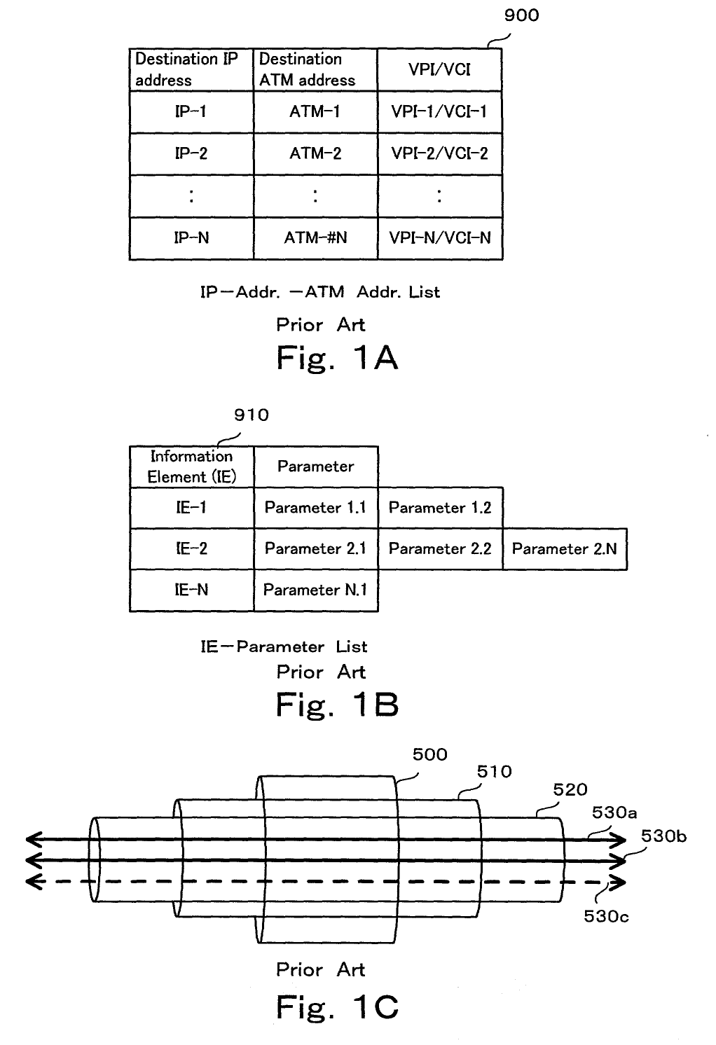

Before the description of preferred embodiments of the present invention, the prior art technologies for IP over ATM connection control system and the connection will be described with reference to FIGS. 1A, 1B, and 1C.

FIG. 1A is a matching table 900 in which destination IP addresses, destination ATM addresses, and VPIs/VCIs of the SVC connection are listed. In the matching table 900, for matching the destination IP addresses, the destination ATM addresses, and the VPIs/VCIs of the SVC connection are matched together on a one-one-one basis, the destination IP addresses correspond to the respective destination ATM addresses using the ATM-ARP function of RFC 1577 IPOA or static-setting. The ATM-ARP function is well known in the art, so that the explanation thereof is omitted. If the data communications in the Internet is performed with the device having a certain IP address, the destination ATM address that corresponds to the target destination IP address is retrieved from the matching table 900 including the destination IP addresses, the destination ATM addresses, and the VPIs/VCIs of the SVC connection. The obtained destination ATM address is set to a Called Party Number (hereinafter, referred to as “CdPN”) that is one of Information Elements (hereinafter, referred to as “IEs”) of the SETUP message for the ATM UNI signaling.

FIG. 1B is a setting-value matching table 910 for matching the conventional information elements against parameters included in the information elements for constructing the information elements except the CdPN IE of the SETUP message for the ATM UNI signaling. In the setting-value matching table 910 shown in FIG. 1B, indispensable IEs except the CdPN are statically defined for constructing the SETUP message being prescribed by UNI 3.1 or UNI 4.0. The indispensable IEs include ATM Traffic Descriptor (hereinafter, referred to as “AtmTD”) IE and Broadband Bearer Capability (hereinafter, referred to as “BBcap”) IE, and QoS Parameter (hereinafter, referred to as “QoS”) IE. After the retrieval of the target destination ATM address from the matching table 900, the retrieval procedure is performed on the setting-value matching table 910 with respect to the information elements except CdPN IE and parameters contained in such information elements to construct other information elements for constructing the SETUP message of the ATM UNI signaling. The ATM UNI signaling is executed using the SETUP messages constructed by CdPN IE, AtmTD IE, BBcap IE, QoS IE, and other IEs to establish the SVC connection on the ATM network for data communications through the Internet.

The VPI/VCI information of the SVC connection established on the ATM network is stored in the columns of VPI/VCI of the matching table 900 of FIG. 1A.

FIG. 1C is an explanation diagram of the logic configuration of SVC connection for the conventional Internet data communications established by the use of tables shown in FIG. 1A and FIG. 1B. A SV connection 510 exists on a physical line 500, and also an IP connection 520 exists on the SV connection 510. Furthermore, a plurality of TCP connections 520a, 530b and an UDP connection 530c exist on the IP connection 520. The UDP is a connectionless-oriented protocol, so that the phrase “UDP connection exists on” may be a wrong phrase to describe the UDP connection just as in the case of TCP. In this embodiment, it is pointed out explicitly.

If the matching table 900 of FIG. 1A is used on the basis of RFC 1577, the destination IP address, the destination ATM address, and the destination SVC connection are provided at the ratio of 1:1:1, so that only one SVC connection is established with respect to one IP address. This is clear from FIG. 1C. If the SVC connection exists with respect to the device that holds the existing IP address, data communications of a plurality of TCP or UDP/IP applications in the Internet share one SVC connection. The connection established between the single SVC connection and a set of TCP connections or UDP connections may be occurred when a certain terminal simultaneously performs e-mail sending, image download, browsing of the Web, and so on.

The problems of such a prior art technologies have been already mentioned. Thus, the following descriptions provide the details of the preferred embodiments of the present invention for providing the solutions of those conventional programs.

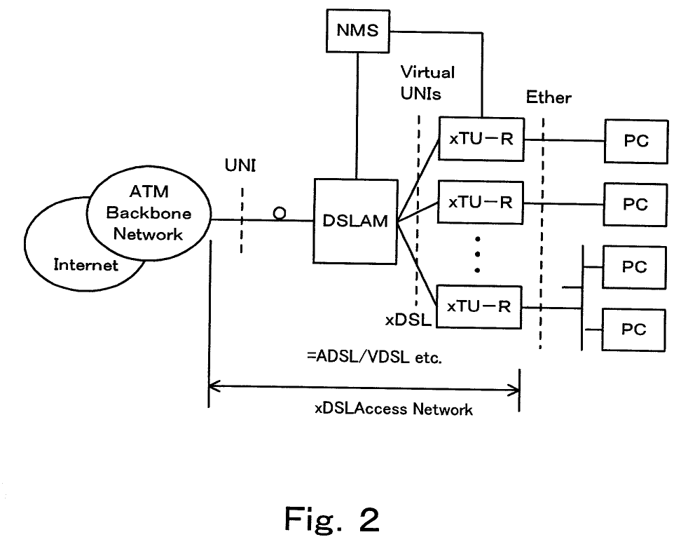

Referring now to FIG. 2, the outline of the present invention is illustrated. In the figure, the network is comprised of a subscriber network, an ATM backbone network, and the Internet. The subscriber network comprises a DSL access multiplexer (DSLAM) and a plurality of xTU-Rs. ADSLs/VDSLs (xDSLs)connect the DSLAMs with the xTU-Rs, respectively. In addition, the UNI signal procedure for controlling the SVX is used as UNI between the ATM back born and the DSLAM, and also used as Virtual-UNI between the DSLAM and xTU-Rs.

### Performance

A traffic type can be recognized by IP packet header when the XTU-R replaces the IP packet on the ATM. The header “Type of Service” at the IPv4 (RFC 791) and the header “Traffic Class” at the IPv6(RFC 2460) are regarded as traffic types. In addition, a port number of the TCP packet is also recognized. Any service (Applications: http, telnet, ftp, smtp, nntp, and so on) requested by the subscribers can be recognized by making a reference to the port number. In this case, the port number denotes “a well-known port number” defined in the RFC 1340. The xTU-R holds the traffic type/port number and a definition table that corresponds to QoS Class IE, Broadband Bearer Capability IE, and ATM Traffic Descriptor IE. A SETUP message can be prepared and transmitted by constructing each of the Information Elements (IEs) such as QoS Class IE, Broadband Bearer Capability IE, and ATM Traffic Descriptor IE. The SETUP message becomes one having an appropriate band QoS information at the TCP/IP application unit.

Therefore, the subscriber may use the existing TCP/IP protocol, and thus both the band and the QoS can be ensured on a service basis. The band between the subscriber network and the public network can be ensured, the quality of the subscriber network can be increased, and the call loss depending on band shortness can be reduced. In the followings, we will describe preferred embodiments in a concrete manner.

### First Preferred Embodiment

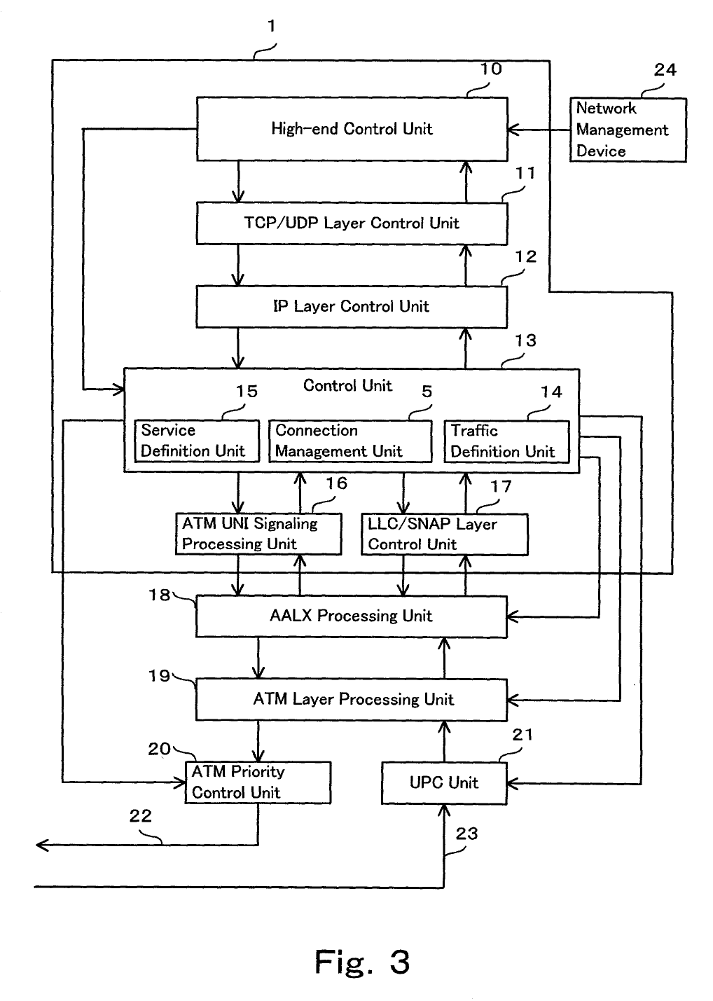

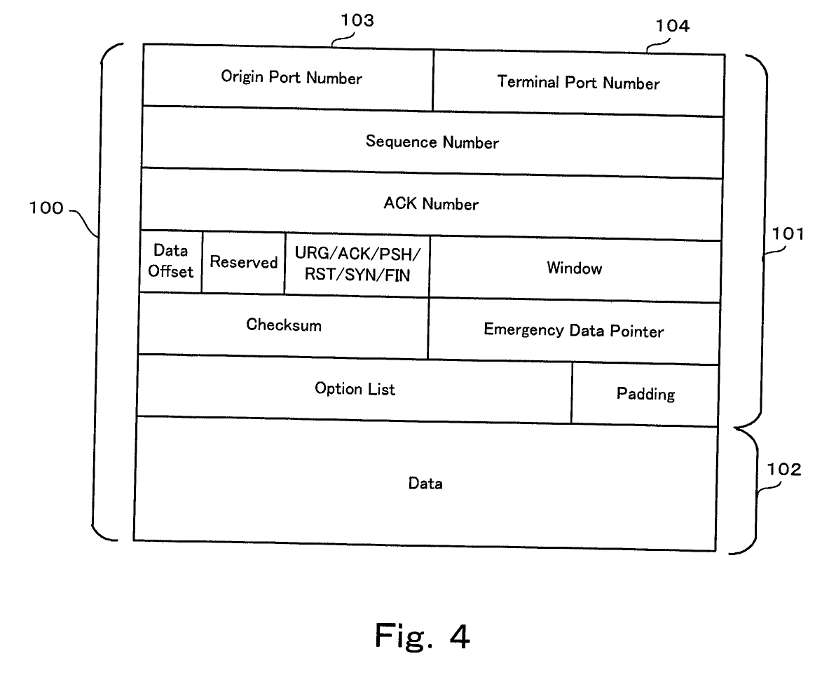

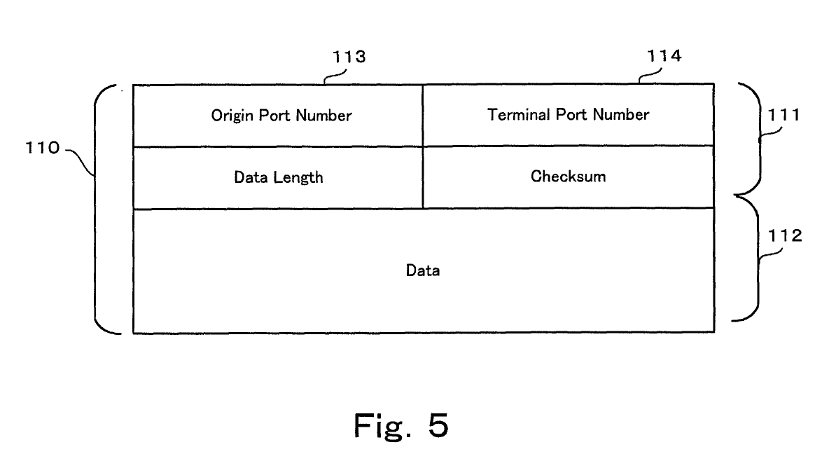

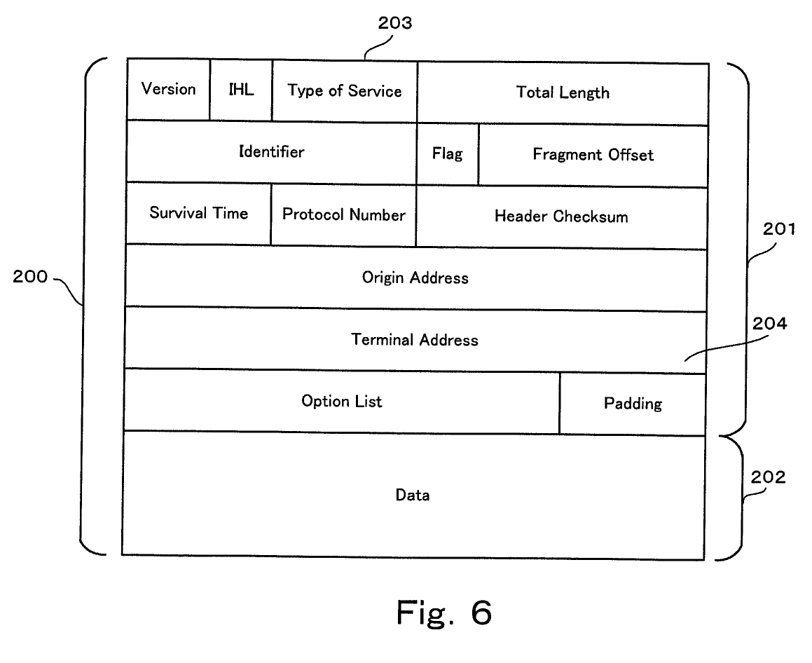

FIG. 3 is a block diagram that illustrates a first preferred embodiment of the present invention. A communication control system of the present embodiment comprises: a high-end control unit 10 that controls the system operation and is provided as TCP or UDP/IP application for providing the user with services such as e-mail, WWW, and FTP; a TCP/UDP layer control unit 11 that executes the protocol procedures of TCP and UDP on the basis of PFC793 TCP and PFC 768 UDP (construct and delete TCP packet header unit 101 (see FIG. 4) and UDP packet header unit 111 (see FIG. 5)); an IP layer control unit 12 that executes the protocol procedures of IPv4 and IPv6on the basis of RFC791 IPv4 and PFC 2460 IPv6(construct and delete IPv4 packet header unit 210 (see FIG. 6) and construct and delete IPv6 packet header unit 211); a control unit 13; an ATMUNI signaling processing unit 16; a LLC/SNAP layer control unit 17, an AALX processing unit 18, an ATM layer processing unit 19, an ATM priority control unit 20, and a UPC unit 21. Thus, the communication control system is capable of carrying out the desired data communications with a network management device 24.

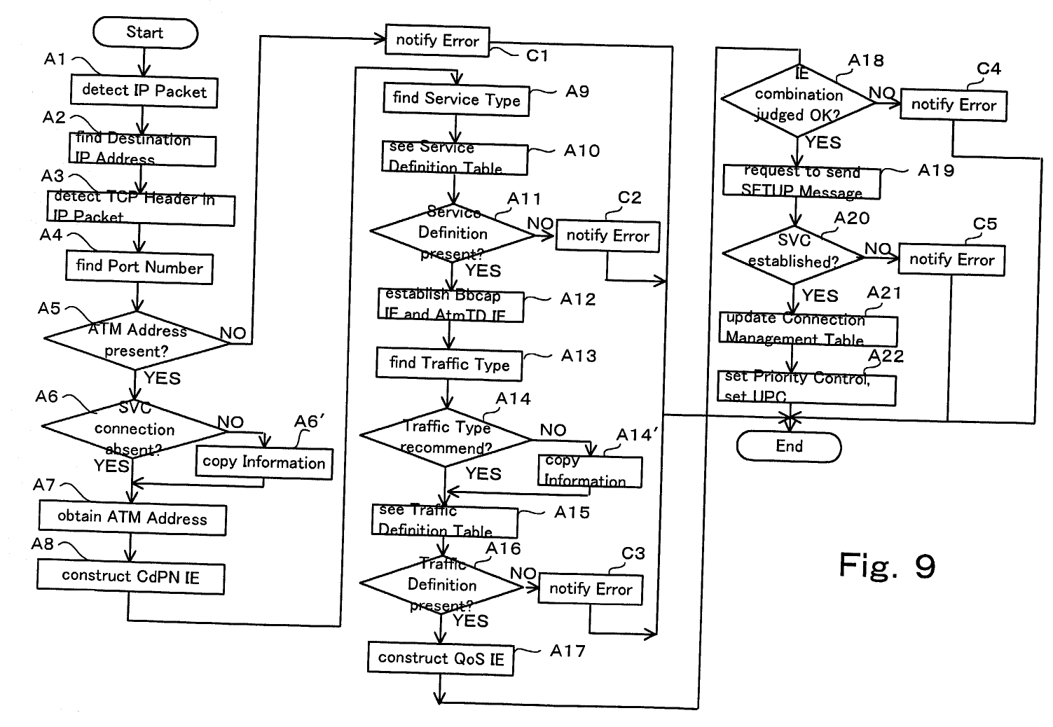

The control unit 13 has the functions of: recognizing the service with reference to a port number to be added by TCP/UDP; recognizing a traffic type; and matching the service unit with the SVC connection that ensures communication band and quality at the ratio of 1:1, followed by executing the process shown in FIG. 9 described latter. The control unit 13 includes a service definition unit 15, a connection management unit 5, and a traffic definition unit 14.

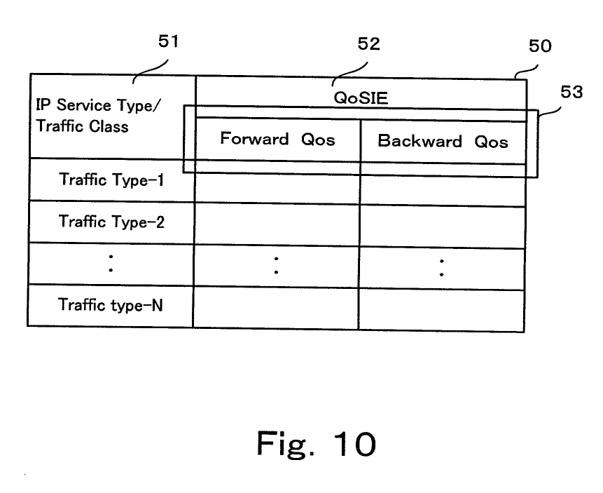

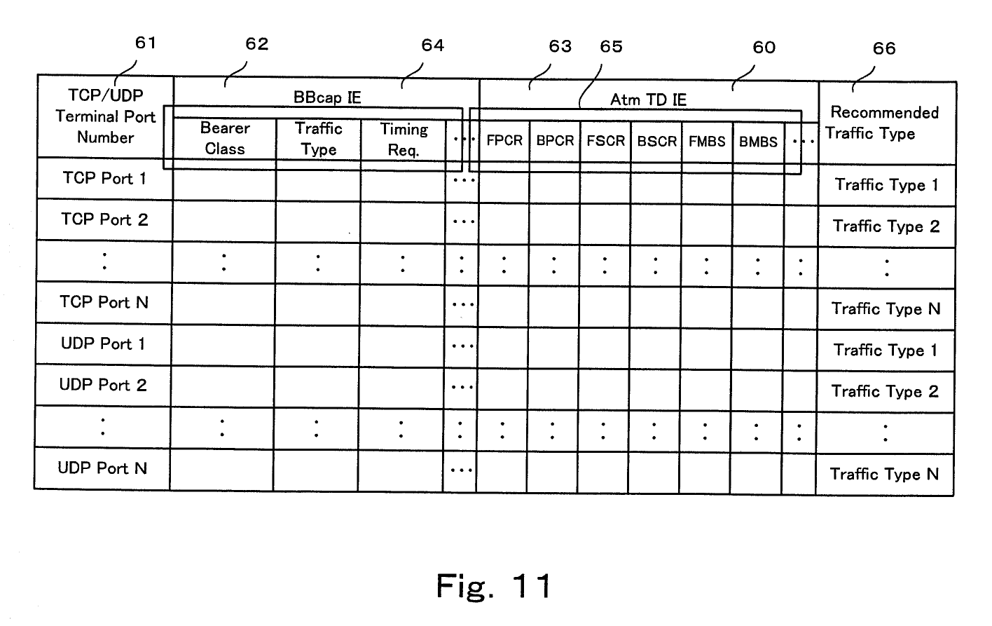

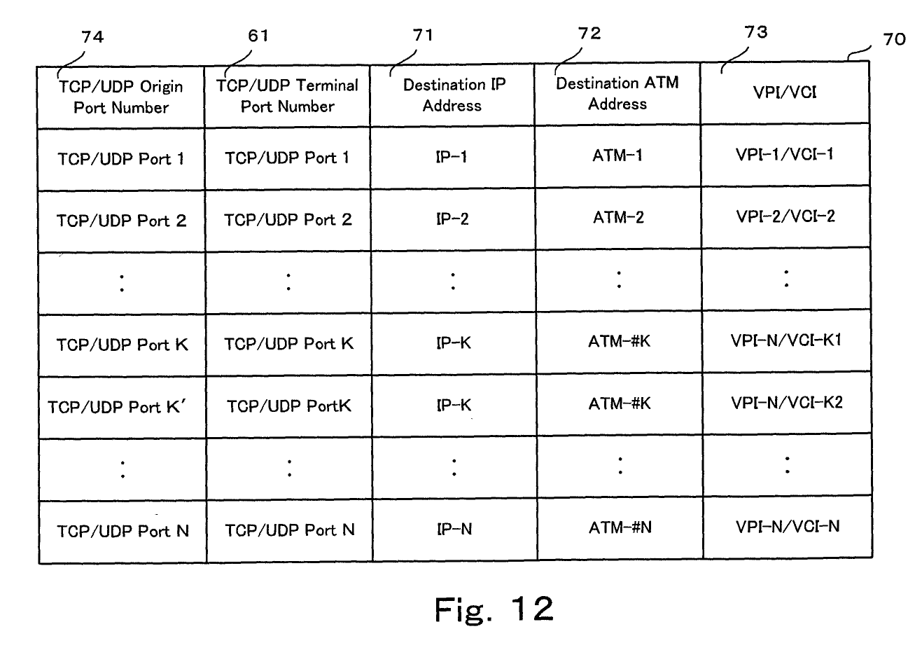

The service definition unit 15 holds a service type definition table (see FIG. 11). The traffic definition unit 14 holds a traffic type definition table (see FIG. 10). The connection management unit 5 holds a connection management table (see FIG. 12). The control unit 13 executes the procedures based on “Muliprotocol Encapsulation over ATM Adaptation Layer 5”, RFC1577 IPoA, RFC1755 “ATM Signaling Support for IP over ATM”, RFC 1755 “ATM Signaling support for IP over ATM”, RFC2331 “ATM Signaling Support for IP over ATM_UNI Signaling 4.0 Update”, RFC2381 “Interoperation of Controlled-Load Service and Guaranteed Service with ATM”, and TM4.0 .

The ATM UNI signaling processing unit 16 is based on UNI 3.1, UNI 4.0, ITU-T recommendation Q.2130 “SSCF (Service Specific Coordination Function” (July 1994) (hereinafter, referred to as SSCF), and ITU-T recommendation QW.2110 “SSCOP (Service Specific Connection Oriented Protocol” (July 1994) (hereinafter, referred to as “SSCOP”), and executes the protocol procedures of ATM UNI signaling with three layers of UNI(3.1/4.0), SSCOP, and SSCF. The LLC/SNAP control unit 17 is based on IEEE 802.2 “Logical Link Control” (hereinafter, referred to as “LLC”) and IEEE 802.1a “SubNetwork Attachment Point” (hereinafter, referred to as “SNAP”), and executes the protocol procedures of LLC and SNAP.

The AAL X processing unit 18 executes the protocol procedures based on ITU-T recommendation I. 363.1 “B-ISDN ATM Adaptation Layer Specification: Type 1 AAL” (August 1996) (hereinafter, referred to as “AAL1”), ITU-T recommendation I. 363.2 “B-ISDN ATM Adaptation Layer specification: Type 2 AAL” (September 1997) (hereinafter, referred to as “AAL2”), ITU-T recommendation I. 363.3 “B-ISDN ATM Adaptation Layer Specification: Type 3 AAL” (August 1996) (hereinafter, referred to as “AAL3”), ITU-T recommendation I. 363.5 “B-ISDN ATM Adaptation Layer Specification: Type 5 AAL” (August 1996) (hereinafter, referred to as “AAL5”), and so on. Thus, AALs 1, 2, 3, and 5 are collectively called AALX.

The ATM layer processing unit 19 executes the procedures based on ITU-T recommendation I. 363.1 “B-ISDN ATM Adaptation Layer Specification” (March 1993) (hereinafter, referred to as “ATM layer”). The ATM priority control unit 20 is called “shaper” and executes the priority control of ATM cell configured by the ATM layer processing unit 19. The UPC unit 21 is called “UPC (Usage Parameter Control)” and keeps watch on the received traffic of the ATM cell. Both the ATM cell priority control unit 20 and the UPC unit 21 have the control functions defined by ITU-T recommendation I. 371 “Traffic Control and Congestion Control in B-ISDN” (March 1993), ATM Forum Technical Committee “Traffic Management Specification Version 4.0” (April 1996) (hereinafter, referred to as “TM 4.0”), UNI3.1, UNI4.0, TM4.0, and so on.

The control unit 13 sets up VPI (Virtual Path Identifier)/VCI (Virtual Channel Identifier) that are identifiers of the established SVC connection with respect to the AALX processing unit 18. In addition, the control unit 13 sets up VPI/VCI that are identifiers of the established SVC connection with respect to the ATM layer control unit 19. Furthermore, the control unit 20 sets up the ATM cell priority control unit 20 and the UPC part 21 by extracting parameter information that regulates the transmission/reception of the ATM cell from QoS IE, AtmTD IE, and BBcap IE that correspond to the established SVC connection. Furthermore, the communication control device establishes connection with: an ATM cell sending-side logic line 22 to be used for sending the ATM cell from the ATM layer processing unit 19 through the ATM cell priority control unit 20; and an ATM cell receiving-side logic line 23 to be used for receiving the ATM cell by the ATM layer processing unit 19 through the UPC unit 21, so that it is connected to the ATM network or the ATM subscriber network. Both the ATM cell sending-side logic line 22 and the ATM cell receiving-side logic line 23 are included in one physical line. However, for facilitating the understanding of the present invention, both lines 22 and 23 are illustrated as independent lines for the sake of convenience.

Each of the units such as the high-end control unit 10, the TCP/UDP layer control unit 11, the IP layer control unit 12, the control unit 13, the ATM UNI signaling control unit 16, and the LLC/SNAP control unit 17 may be mounted as a CPU unit 1 of the communication control unit. In addition, the AALX processing unit 18, the ATM layer processing unit 19, the ATM cell priority control unit 20, and the UPC unit 20 may be provided as a hardware unit of the system. Furthermore, the network management device 24 performs the management and monitoring of ATM network. Also, the network management device 24 performs update of the information of a service type definition table held in the service definition unit 15 and a traffic type definition table held in the traffic definition unit 14 in accordance with the conditions of the network. Therefore, the network management device 24 is capable of establishing connection with the high-end control unit 10 for the communications of desired information.

If the high-end control unit 10 receives the service type definition table held in the service definition unit 15 and a traffic type definition table held in the traffic definition unit 14 from the network management device 24, then the high-end control unit 10 makes a request of the control unit 13 to update the information of the service type definition table and the traffic type definition table. Consequently, the service type definition table and the traffic type definition table of the control unit 13 may always include the communication band and communication quality, which can be ensured by the ATM network or the ATM subscriber network.

FIG. 4 is a schematic diagram that illustrates a TCP packet to be controlled by the TCP/UDP layer control unit 11. The TCP packet 100 comprises a TCP packet header portion 101 and a TCP packet data portion 102. The TCP packet header portion 101 includes the information defined by PFC 7893 TCP, such as a TCP origin port number 103 and a TCP terminal port number 104. In addition, the TCP packet data portion 102 stores data received from the high-end control unit 10. If the TCP/UDP control unit 11 receives data from the high-end unit 10, the TCP header portion 101 is constructed and the sending data is stored in the TCP data portion 102. Then, the TCP packet is constructed and passed to the IP layer control unit 12. If the TCP/UDP layer control unit 11 receives data from the IP layer control unit 12, on the other hand, the TCP header portion 101 is deleted. Then, the received data is extracted from the TCP data portion 102 and sent to the high-end control unit 10.

FIG. 5 is a schematic diagram that illustrates a UDP packet to be controlled by the TCP/UDP layer control unit 11. The UDP packet 110 comprises a UDP packet header portion 111 and a UDP packet data portion 112. The UDP packet header portion 111 includes the information defined by RFC 7688 UDP, such as a UDP origin port number 113 and a UDP terminal port number 114. In addition, the UDP packet data portion 112 stores data received from the high-end control unit 10. If the TCP/UDP control unit 11 receives data from the high-end unit 10, the UDP header portion 111 is constructed and the sending data is stored in the UDP data portion 112. Then, the UDP packet 110 is constructed and passed to the IP layer control unit 12. If the TCP/UDP layer control unit 11 receives data from the IP layer control unit 12, on the other hand, the UDP header portion 111 is deleted. Then, the received data is extracted from the UDP data portion 112 and sent to the high-end control unit 10.

The high-end control unit 10 controls the operation of either TCP or UDP in the TCP/UDP layer control unit 11. The control of the high-end control unit 10 against the UDP layer control unit 11 is performed by the so-called “socket” well known in the art, so that further description of the socket is omitted.

FIG. 6 is a schematic diagram that illustrates an IPv4 packet to be controlled by the IP layer control unit 12. The IPv4 packet 200 comprises a IPv4 packet header portion 201 and a IPv4 packet data portion 202. The IPv4 packet header portion 201 includes the information defined by RFC 791 IPv4, such as a Type of Service 203 and a IPv4 terminal port address 104. In addition, the IPv4 packet data portion 202 stores data received from the TCP/UDP layer control unit 11. That is, the TCP packet 100 and the UDP packet 110 are stored. If the IP control unit 12 receives data from the TCP/UDP layer control unit 11, the IPv4 header portion 201 is constructed and the sending data such as TCP packet 100 and the UDP packet 110 is stored in the IPv4 data portion 202. On the other hand, if the IP layer control unit 12 receives data from the control unit 13, the IPv4 header portion 201 is deleted. Then, the received data such as TCP packet 100 and the UDP packet 110 is extracted from the IPv4 data portion 202 and sent to the TCP/UDP layer control unit 11.

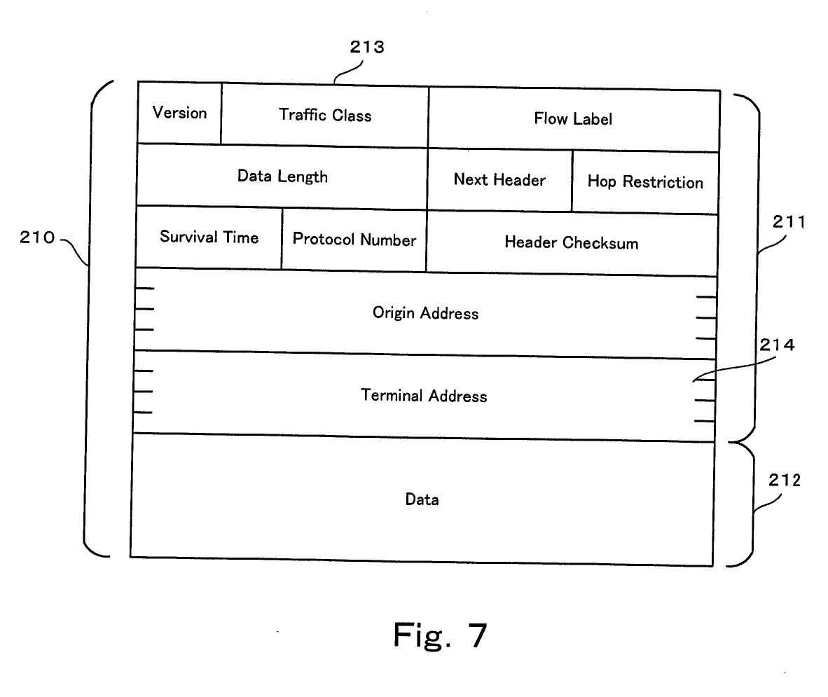

FIG. 7 is a schematic diagram that illustrates an IPv6packet to be controlled by the IP layer control unit 12. The IPv6packet 210 comprises a IPv6packet header portion 211 and a IPv6packet data portion 212. The IPv6packet header portion 211 includes the information defined by RFC 2460 IPv6, such as a Traffic Class 213 and a IPv6terminal port address 214. In addition, the IPv6 packet data portion 212 stores data received from the TCP/UDP layer control unit 11. That is, the TCP packet 100 and the UDP packet 110 are stored. If the IP control unit 12 receives data from the TCP/UDP layer control unit 11, the IPv6 header portion 211 is constructed and the sending data such as TCP packet 100 and the UDP packet 110 is stored in the IPv6 data portion 212. On the other hand, if the IP layer control unit 12 receives data from the control unit 13, the IPv6 header portion 211 is deleted. Then, the received data such as TCP packet 100 and the UDP packet 110 is extracted from the IPv6 data portion 212 and sent to the TCP/UDP layer control unit 11.

Either the protocol of IP or the protocol of IPv6 may be operated in the IP layer control unit 12, depending on the Internet. If the Internet or the service provider provides IP network, the protocol of IP is mounted on the IP layer control unit 12. If the IPv6 network is provided, alternatively, the IPv6 is mounted on the IP layer control unit 12.

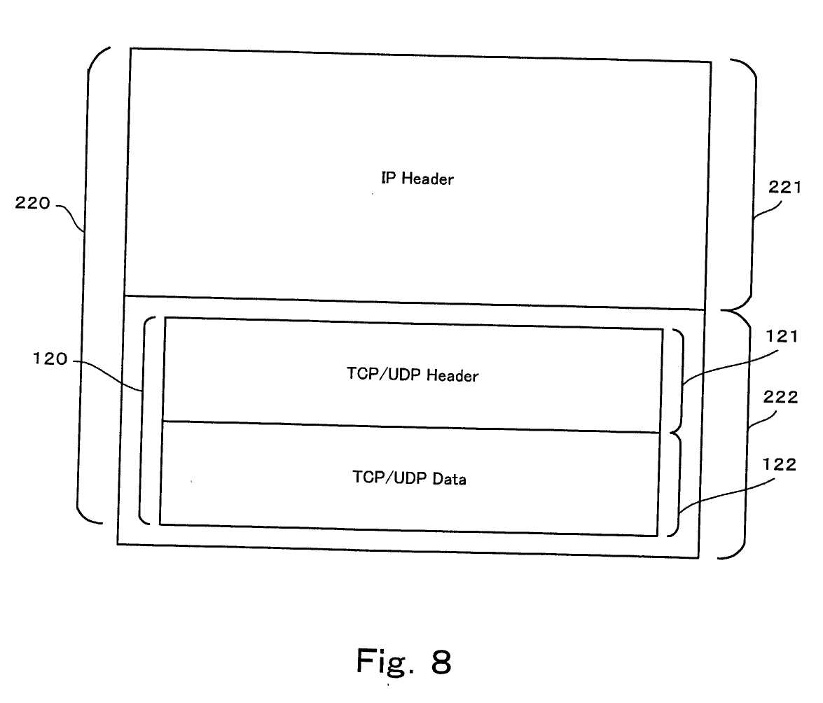

FIG. 8 is a schematic diagram that illustrates an IP packet to be detected by the control unit 13. FIG. 8 includes all of the structural components shown in FIGS. 4 to 7. The IP packet 220 comprises a IP packet header portion 221 and a IP packet data portion 222. The IP packet data portion 222 includes TCP/UDP packet 120. The TCP/UDP packet 120 comprises a TCP/UDP header portion 121 and a TCP/UDP data portion 122. In the IP packet header portion 221, the IPv4 packet header portion 201 or the IPv6 packet header portion 211 are configured. Furthermore, the TCP packet header portion 101 and the UDP packet header portion 111 are configured in the RTCP/UDP header portion 121. The control unit 14 receives the IP packet 220 from the IP layer control unit 12 or the LLC/SNAP layer control unit 17.

The high-end control unit 10 sends data from the ATM cell receiving-side logic line 22 to the ATM network or the ATM subscriber network through the TCP/UDP layer control unit 11, the IP layer control unit 12, the control unit 13, the LLC/SNAP layer control unit 17, the AAL X processing unit 18, the ATM layer processing unit 19, and the ATM cell priority control unit 20. On the other hand, the high-end control unit 10 receives data from the ATM network or the ATM subscriber network through the ATM cell receiving-side logic line 23, the UPC unit 21, the ATM layer processing unit 19, the AAL X processing unit 18, the LLC/SNAP layer control unit 17, the control unit 13, the IP layer control unit 12, and the TCP/UDP layer control unit 11. The LLC/SNAP layer control unit 17, the AAL X processing unit 18, the ATM layer processing unit 19, and the ATM cell priority control unit 20 can be implemented by the protocols and technologies well known in the prior art, so that their descriptions are omitted.

The control unit 13 only performs the transmission/reception of data to the IP layer control unit 12 and the AAL X processing unit 18 in a transparent manner when the establishing SVC connection exists with respect to the ATM network or the ATM subscriber network, i.e., when VPI/VCI of the SVC connection exists. However, the control unit 13 requests the establishment of the SVC connection for data transmission/reception to the ATM UNI signaling processing unit 16 when the SVC connection for data transmission/reception is absent in the ATM network or the ATM subscriber network, i.e., when VPI/VCI of the SVC connection is not registered in the connection management unit 5. After completing the request of establishing the SVC connection in a successful manner, VPI/VCI of the SVC connection is configured in the connection management table being held in the connection management unit 5 and then the information is updated.

The ATM UNI signaling message defined by UNI 3.1 or UNI. 40 configured and analyzed by the ATM UNI signaling processing unit 16 is transmitted to the ATM network or the ATM subscriber network through the AALX processing unit 18, the ATM layer processing unit 19, and the ATM cell priority control unit 20. On the other hand, the reception of the message is performed by the ATM cell receiving-side logic line 23 through the UPC unit 21, the ATM layer processing unit 19, and the AALX processing unit 18. The AALX layer processing unit 18 processes the received message as the ATM UNI signaling message AAL5 on the basis of the definition of UNI 3.1 or UNI 4.0. In this case, the ATM signaling processing unit 16 includes SSCF and SSCOP. They are used as standard protocols for providing the communications with the reliable ATM UNI signaling message, so that the description of these protocols will be omitted in the following description.

FIG. 10 is an explanation diagram that illustrates a traffic type definition table. The traffic type definition table 50 comprises traffic type information 51 and QoSIE information. The traffic type information 51 is a generic name of a traffic class 213 for the Type of Service portion 203 of the IPv4 packet header portion 200 constructed by the IP layer control unit 12. The QoSIE 52 defines the communication quality of the SVC connection, which is specified by UNI 3.1, UNI 4.0, or TM 4.0 and to be required for constructing the SETUP message of the ATM UNI signaling message.

In the QoS IE 52, parameters 53 defined by UNI 3.1, UNI 4.0, or TM 4.0 may be registered. The traffic type definition table 50 is provided as a matching table on which the traffic type 51 and the QoS IE parameter 53 are matched together and stored therein. The matching information of the traffic type 51 and the QoSIE parameter 53 is held in the traffic type definition table 50, and the matching information may be updated by appropriate information in accordance with the resource conditions of the network from the network management device through the high-end control unit 10. Furthermore, the network management device 24 may add an additional parameter to the QoSIE parameter 53 or delete an undesired parameter therefrom to update the information by the network management device 24 as the definitions of UNI 3.1, UNI 4.0, and TM 4.0 are changed by ATM Forum. Accordingly, the parameter information can be stored in the traffic definition table 50 for ensuring an appropriate communications band and the communication quality.

FIG. 11 is an explanation diagram that illustrates a service time definition table 60. The service definition table 60 comprises a table that is held in the service definition unit 15 of the control unit 13 and referenced by the control unit 13. The service definition table 60 extracts TCP/UDP packet 120 stored in the IP packet data portion 222 constructed by the IP layer control unit 12. Furthermore, the service definition table 60 comprises a TCP terminal port number 104 of the TCP packet header portion 100 configured in the TCP/UDP packet header portion 121 of the TCP/UDP packet 120, or a UDP terminal port number 114 of the UDP packet header portion 110. In other words, the service definition table 60 comprises: TCP/UDP terminal port number information 61 that indicates the terminal port number of TCP or UDP; BBCap IE information 62 that defines traffic and connection types (e.g., “Point-to-point” and “Point-to-Multipoint”) and is required for the construction of SETUP message provided as an ATM UNI signaling message specified by UNI 3.1, UNI 4.0, or TM 4.0; the AtmTD IE information 63 that defines the communication bund and priority control of the SVC connection; and a recommended traffic type 66 that corresponds to each TCP/UDP terminal port number.

In the columns for the TCP/UDP terminal port numbers 61 in the table, well-known port numbers of TCP and UDP to be used in Voice over IP, Image over IP, and so on, which are recently available services, may be entered. These numbers are defined in IETF RFC 1340 “Assigned Numbers” (July 1992) (which may be revised or extended). Regarding the well known number of TCP, the port number corresponds to the respective service type, for example the port number “20” for “ftp” and the port number “80” for “WWW”. That is, the service types of high-end application that requires the SVC connection can be grasped by recognizing the terminal port number of the TCP or UDP packet header. Consequently, it becomes possible to construct a SETUP message of the ATM UNI signaling that controls the SVC connection capable of providing the communication band and quality corresponding to the high-end application's service. That is, the TCP/UDP terminal port number 61 is substantially the same meaning as that of the recognition of service type.

Furthermore, there is a service in which TCP and UDP use the same port number, so that the TCP's port number and the UDP's port number are arranged in the service definition table 60 such that these numbers can be distinguished from one another. In the BBcCap IE information 62, BDcap IE parameters 64 specified by UNI 3.1, UNI 4.0, and TM 4.0 are registered. Also, AtmTD IE parameters 65 specified by UNI 3.1, UNI 4.0, and TM 4.0 are registered in the AtmTD IE information 63. The recommended traffic types 86 are information items that define the minimum communication-quality traffic types to be required. If the traffic type that corresponds to the service recognized from the TCP/UDP's port number is not configured to the Type of Service portion 203 or the IPv6 packet header portion 210, the recommended traffic type 66 may be used as an alternative. The IPv4 and IPv6 do not specify the construction of communication-quality for the traffic type corresponding to the service. In addition, the communication-quality information adapted to the network may be constructed as a combination of the service and the traffic type.

The service type definition table 60 is provided as a matching table that stores information of parameters or the like including the TCP/UDP terminal port numbers (service types) 61, the BBcap IE parameters 64, the Atm TD IE parameters 65, the recommended traffic type 66 which are brought into correspondence with one to the other. The corresponding data of TCP/UDP terminal port numbers (service types) 61, the BBcap IE parameters 64, the Atm TD IE parameters 65 can be appropriately updated in response to the resource status of the network from the network management device through the high-end control unit 10. Furthermore, as the definitions of UNI 3.1, UNI 4.0, and TN 4.0 are changed, the update of information is performed by the addition of additional parameters or the deletion of undesired parameters from the BBcap IE parameters 64 and the AtmTD IE parameters 65 to update the information. Therefore, the parameter information for ensuring the communication band and the communication quality in an appropriate manner may be stored on the basis of every terminal port number 61.

FIG. 12 is an explanation diagram that illustrates a connection management table 70. The connection management table 70 is held by the connection management portion 5 of the control unit 13 and referenced by the control unit 13. The connection management table 70 extracts TCP/UDP packet 120 stored in the IP packet data portion 222 of the IP packet 220 constructed by the IP layer control unit 12. Furthermore, the connection management table 70 comprises a TCP terminal port number 104 of the TCP packet header portion 100 configured in the TCP/UDP packet header portion 121 of the TCP/UDP packet 120, or a UDP terminal port number 114 of the UDP packet header portion 110. In other words, the connection management table 70 comprises: TCP/UDP terminal port number information 61; and IPv6 terminal address 214 of the IPv6 packed header portion 210 or IPv4 terminal address portion 204 of the IPv4 packet header portion 200 constructed by the IP layer control portion 12. That is, it comprises: the destination IP address information 71; the destination ATM address information 72 corresponding to the destination IP address obtained by means of static configuration or ATM-ARP function based on RFC 1577 IPoA; VPI/VCI information 73 that indicates VCI and VPI established by the ATM UNI signaling procedure with the definitions of UNI 3.1 and UNI 4.0; and TCP/UDP origin port number 74 for establishing another SVD connection with respect to the identical TCP/UDP terminal port number information 61, the identical destination IP address information 71, and the identical ATM address information 72.

In the columns for the TCP/UDP terminal port numbers 61 in the table, well-known port numbers of TCP and UDP to be used in Voice over IP, Image over IP, and so on, which are recently available services, may be entered. These numbers are defined in IETF RFC 1340 “Assigned Numbers” (July 1992) (which may be revised or extended). Furthermore, there is a service in which TCP and UDP use the same port number, so that the TCP's port number and the UDP's port number are arranged in the connection management table 70. Therefore, just as in the case of the service definition table 60, these numbers can be distinguished from one another in the connection management table 70. The connection management table 70 also holds the information of TCP/UDP terminal port number 61 but it is managed aside from the TCP/UDP terminal port number 61 of the service definition table 60. Regarding the ATM-ARP function for configuring the destination ATM address 72 that corresponds to the destination IP address 71, the explanation of such a function will be omitted from the following description because it is well known in the art. The connection management table 70 is used for control of the connection by the control unit 13. One SVC connection is established per one TCP/UDP terminal port number 61.

If the SVC connection for data communications has already established to the TCP/UDP terminal port number 61, VPI/VCI that recognizes the SVC connection is registered in the CPI/VCI portion 73 of the connection management table 70. In addition, the TCP origin port number 103 or the UDP origin port number 113 are registered in the TCP/UDP origin port number 74 for recognizing the high-end application. If the requests of data communications are regenerated to the TCP/UDP terminal port number 61, the destination IP address 71, and the destination ATM address 72, on which the SVC connections has already established, TCP/UDP terminal port number 61, the destination IP address 71, and the destination ATM address 72 are copied into another area of the connection management table 70 and then the VPI/VCI portion 73 is configured after establishing the SVC connection. At this time, for managing the application on the high-end control unit 10, the TCP origin port number 103 or the UDP origin port number 113 are configured to the TCP/UDP origin port number 74 of the connection management table 70 to recognize the connected components.

On the other hand, if the SVC connection for data communications is not established to the TCP/UDP terminal port number 61, VPI/VCI for recognizing the connection is not registered on the VPI/VCI portion 73 of the connection management table 70. In this case, the TCP/UDP origin port number 74 is also not registered. The TCP/UDP terminal port number 61 and the destination IP address 71 are holed by the connection management table 70 and updated or statically held by the status of the IP address of the service-providing server on the network through the high-end control unit 10 from the network management device 24.

Next, we will describe the operation of the first preferred embodiment of the present invention. The high-end control unit 10 transmits the sending data to the TCP/UDP layer control unit 11. Then, the TCP/UDP layer control unit 11 constructs the TCP packet 100 or the UDP packet 110 and then transmits the packet to the IP layer control unit 12. The IP layer control unit 12 constructs the IPv4 packet 200 or the IPv6 packet 200 and then transmits the packet to the control unit 13. Consequently, the control unit 13 receives the IP packet 220.

FIG. 9 is a flow chart for illustrating the operation of the first preferred embodiment of the present invention. The control unit 13 detects the IP packet 220 (Step A1). Then, the control unit 13 recognizes the IPv4 terminal address 204 of the IPv4 packet header 201 or the IPv6 terminal address of the IPv6 packet header 211 (Step A2). Furthermore, TCP/UDP packet 120 stored in the IP packet data portion 222 of the IP packet 200 is extracted (Step A3). Furthermore, the TCP origin port number 103 and the TCP terminal port number 104 of the TCP/UFP packet header portion 100 in the TCP/UDP packet 120 are recognized. Alternatively, the UDP origin port member 113 and the UDP terminal port number 114 of the UDP packet header portion 110 in the TCP/UDP packet 120 are recognized (Step A4). Then, the control unit 13 accesses to the connection management table 70 to verify that the destination IP address recognized at the step A2 and the TCP/UDP terminal port number recognized at the step 4 are entered into the TCP/UDP terminal port number 61 and the destination IP address 71, respectively, followed by confirming the entry of the destination ATM address 72 by means of the ATM-ARP function or static configuration (Step A5).

If the destination ATM address 72 is not registered, that is, if the address-problem solving is not performed, then the error handling is performed and then the process is terminated (Step C1). Next, the control unit 13 is accessed to verify that there is no information in a portion of the VPI/VCI portion 73, which corresponds to the connection management table 70 recognized at the step A5. That is, it is confirmed that the SVC connection is not established (Step A6). In this case, if the information is configured in the VPI/VCI part 73 (that is if the SVC connection has already established), each information of the TCP/UDP terminal port number 61, the destination IP address 71, and the destination ATM address 72 are copied to another area of the connection management table 70. Subsequently, the TVP/UDP origin port number recognized at the step a4 is configured to the TCP/UDP origin port number 74 (Step A6′). Next, the control unit 13 obtains the information of destination ATM address 72 from the connection manage table 70 (Step A7). Subsequently, Called Party Number (CdPN) IE to be required for a SETUP message of the ATM UNI signaling message is constructed with reference to the destination ATM address detected at the step A7.

Then, the TCP/UDP terminal port number 61 of the TCP/UDP ort number recognized at the step A4 is identified as a service type (step A9). Next, the service definition table 60 held in the service definition unit 15 is accessed (Step A10), with reference to the UDP terminal port number 61, to verify that the service is defined in the service definition table 60, and then BBCap IE parameter information 64 and AtmTD IE parameter information 64 are obtained for the purpose of constructing the Broadband Bearer Capability IE and ATM Traffic descriptor IE5. Here, if the service is not defined in the service definition table 60, the error-resolving procedure is performed and the process is terminated (Step C2).

Next, the BBcap IE and the Atm TD IE can be constructed using the BBCapIE parameter information 64 and the AtmTD IE parameter information 65 (Step A12). Subsequently, the traffic types corresponding to the Type of Service 203 in the IPv4 packet 201 or the Traffic Class 213 in the IPv6 packet header 211 are recognized (Step A13). Repeatedly, furthermore, the service definition table 60 is accessed again. The traffic type recognized at the step A13 and the recommended traffic time table 66 of the TCP/USP terminal port 61 registered in the service definition table 60 are compared with each other. If the traffic type gives satisfaction, then the process forwards to the step A15 (Step A14). On the other hand, if the traffic type is redundant or insufficient, the information about the recommending traffic type 66 of the TCP/UDP terminal port number 61 for the service recognized at the step A4, which is being registered in the service definition table 60, is copied (Step A14′). In the step A14′, the traffic type information is reconstructed.

Subsequently, the traffic definition table 50 held in the traffic definition unit 14 is accessed (Step A15). Then, the IP service type/traffic class portion 51 of the traffic definition table 50 is referred for confirming that it is defined in the traffic type to get the QoS IE Parameter information 53 to be required to the SETUP message of the ATM UNI signaling message is obtained (Step A16). If the traffic type of Type of Service 203 or Traffic Class 213 recognized at the step A13 is not registered, then the error handling is performed and then the process is terminated (Step C3).

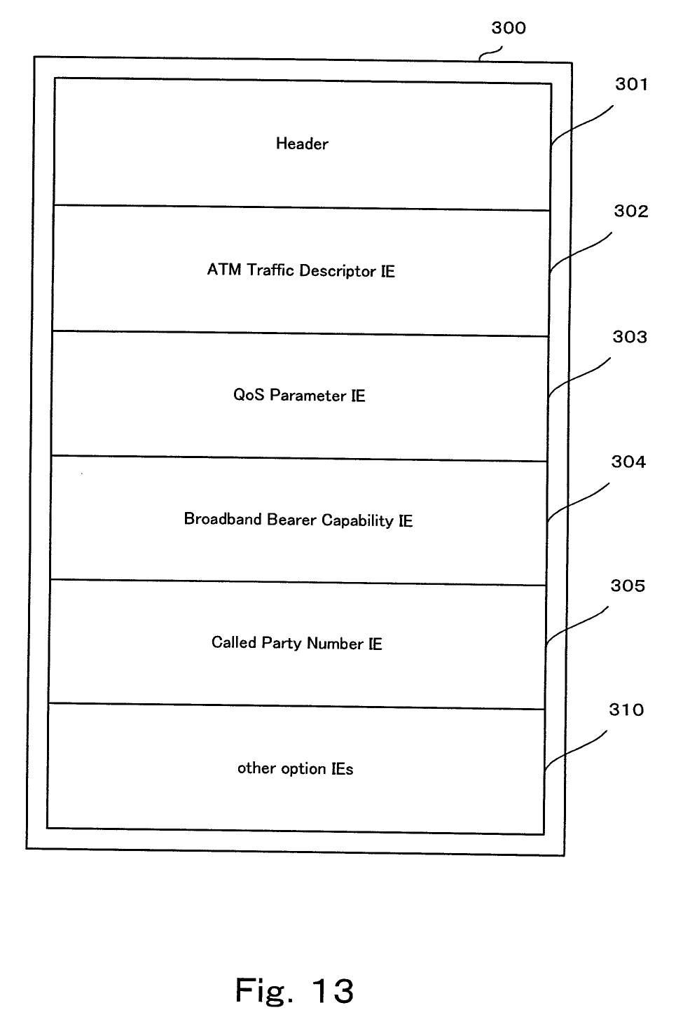

Next, the QoSPIE IE is constructed from the QosP IE parameter information 53 obtained at the step A11. Subsequently, the process proceeds to determine whether an information combination between the BBCap IE and AtmRD IE constructed at the step A12 and the QoSP IE constructed at the step A15 is a correct information combination based on UNI 3.1, UNI 4.0, or TM 4.0 (Step A18). If there is a mismatch in the information combination, then the error handling is performed and then the process is terminated (Step C4). Next, the control unit 13 makes a request of sending the constructed SETUP message (see FIG. 13) to the ATM UNI signaling processing unit 16 (Step 19).

FIG. 13 is a schematic diagram that illustrates a SETUP message defined by UNI 3.1 or UNI 4.0 to be used in the present invention. The SETUP message 300 is constructed by the control unit 13. The SETUP message 300 comprises a header 301, an ATM traffic descriptor information element 302 constructed at the step A12, a QoS parameter information element 303, a Broadband bearer capability information element 304 constructed at the step A12, a Called party number information element 305 constructed at the step A17, and other option information elements 310.

In the step A19, the ATM UNI signaling processing unit 16, on which the request of sending the SETUP message 300 is provided, attempts to establish the SVC connection by executing the ATM UNI signaling procedure. If the SVC connection has established (Step A20), the control unit 13 accesses the connection management table 70 to configure the VPI/VCI information of the SVC connection on the VPI/VCI portion 73 of the connection management table 70 recognized at the step A5 (Step A21). If the establishment of SVC connection has failed, then the error handling is performed and then the process is terminated (Step C1).

Next, the control unit 13 allows that the ATM cell priority control unit 20 and the UPC unit 21 are respectively configured to the communication band information and the communication quality information of the established SVC connection using the BBcap IE parameter 64 and the AtmTD IE parameter 65 obtained at the step A11 and the QoS IE parameter 53 obtained at the step A16, and also the AALX layer processing unit 18 and the aTM layer processing unit 21 are configured to VPI/VCI of the SVC connection, and subsequently the ATM cell sending-side logic line 22 and the ATM cell receiving-side logic line 23 are opened, followed by the termination of a series of the processing steps (Step A22).

In accordance with the present embodiment, for the TCP or UDP application, a SETUP message is generated using the parameters depending on the service type defined by the terminal port number, and then transmitted to establish a connection. For the IP application, a SETUP message is generated using the parameter information depending on the traffic type defined by a service type or a traffic type, and then transmitted to establish a connection.

### Second Preferred Embodiment

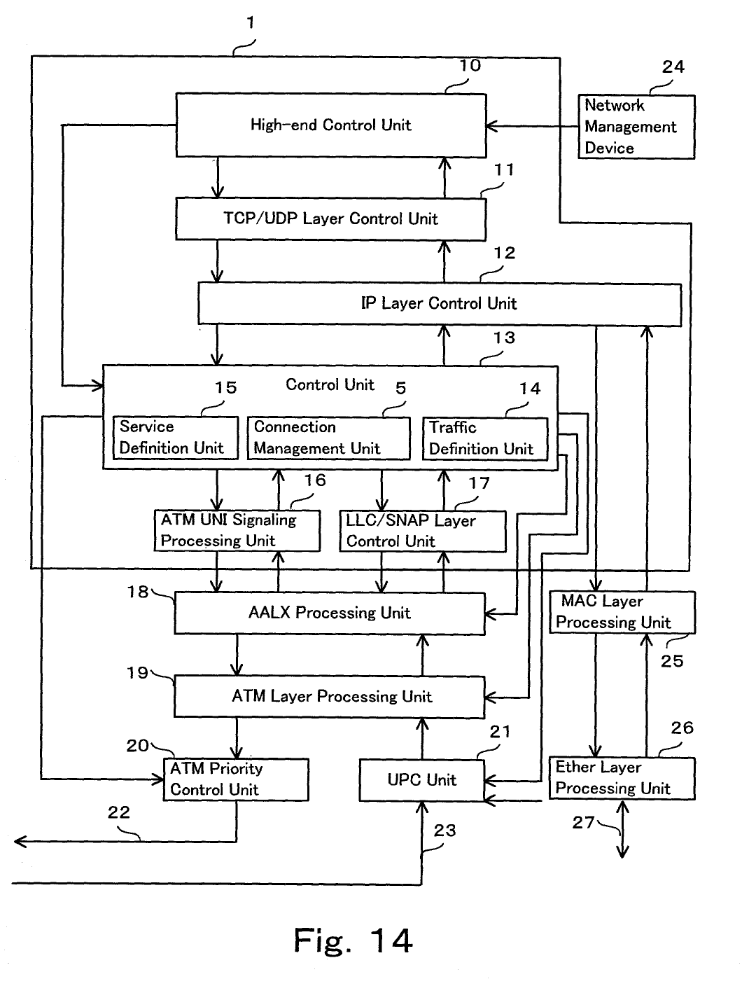

Next, a second preferred embodiment of the present invention will be described below. FIG. 14 is a block diagram that illustrates a communication control system in accordance with a second preferred embodiment of the present invention. As can be seen from FIG. 14, the construction of the second embodiment is the same as that of the first embodiment, except that the present embodiment further comprises a MAC layer processing unit 25, and an Ether packet transmission/reception line 27, so that the IP layer control unit 12 provided as a network layer has a routing function. The MAC layer processing unit 25 executes the processing of the MAC layer, while the Ether layer processing unit 26 performs the processing the Ether layer. Both the MAC layer control unit 25 and the Ether layer control unit 26 are currently available general protocols.

If the he high-end control unit 10 performs the data transmission/reception using both the ATM cell sending-side line 22 and the ATM cell receiving-side line 23, the high-end control unit 10 performs the same procedure as that of the first preferred embodiment. In addition, the high-end control unit 10 sends data from the Ether packet control unit 10 to the Ether network through the TCP/UDP layer control unit 11, the IP layer control unit 12, the MAC layer processing unit 25, and the Ether layer processing unit 26. On the other hand, the high-end control unit 10 receives data from the Ether net through the Ether packet transmission/reception line 27, the Ether layer processing unit 26, the MAC layer processing unit 25, the IP layer control unit, and the TCP/UDP layer control unit 11.

Furthermore, if the data is transmitted from the Ether net work to the ATM network or the ATM subscriber network, the data is received by the ether packet transmission/reception line 27, and then the data is passed to the IP layer control unit 12 through the Ether layer processing unit 26 and the MAC layer processing unit 25. Then, the IP layer control unit 12 performs a routing process. Subsequently, the data is transmitted from the ATM sell sending-side logical line 22 to the ATM network or ATM subscriber network through the control unit 13, the LLC/SNAP layer control unit 17, the AAL X processing unit 18, ATM layer processing unit 19, and the ATM cell priority control unit 20. On the other hand, if the data is transmitted from the ATM network or the ATM subscriber network to the Ether network, the ATM cell receiving-side logic line 23 receives the data and then passes the data to the IP layer control unit 12 through the UPC unit 21, the ATM layer processing unit 19, the AALX processing unit 18, the LLC/SNAP layer control unit 17, and the control unit 13. Thus, the IP layer control unit 12 executes the routing process. Subsequently, the data is transmitted from the Ether packet transmission/reception line 17 to the Ether network through the MAC layer processing unit 25 and the Ether layer processing unit 265. By the way, any configuration of the routing table or routing table or routing table construction algorism have been well known in the art, so that the explanation of such an algorism is omitted in the following description.

The operation of the second embodiment is substantially the same as that of the first embodiment, so that the description thereof will be omitted. If data transmission and reception are performed from the Ether network to the ATM network or ATM subscriber network through the communication control system of the second embodiment, an IPv4 terminal address 204 or an IPv6 terminal address 214 contained in an IP packet header portion 221 of an IP packet 200 received from the MAC layer control unit 25 is designed to be rewritten to an IP address of the other terminal to be connected through the ATM network or the ATM subscriber network. The present embodiment can be adaptable to a routing feature that is provided on the IP layer control unit 12, so that data transmission and reception can be performed by changing the Ether packet to the ATM cell. That is, the Ether network to which the Ether packet transmission/reception line 27 is connected is known in the art. In this embodiment, however, it comprises the system configuration of the second embodiment, so that it shows excellent advantages because of being operated by the same way as that of the first embodiment. Therefore, the ATM SVC connection to the ATM network or the ATM subscriber network allows the connection with ensured communication band and quality.

### Third Preferred Embodiment

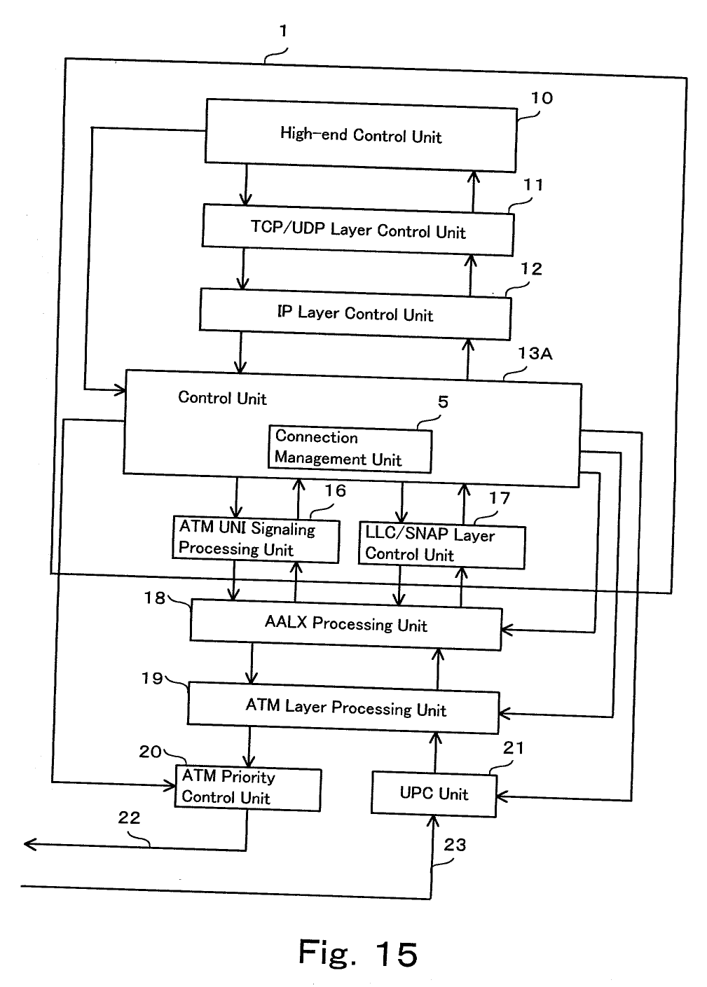

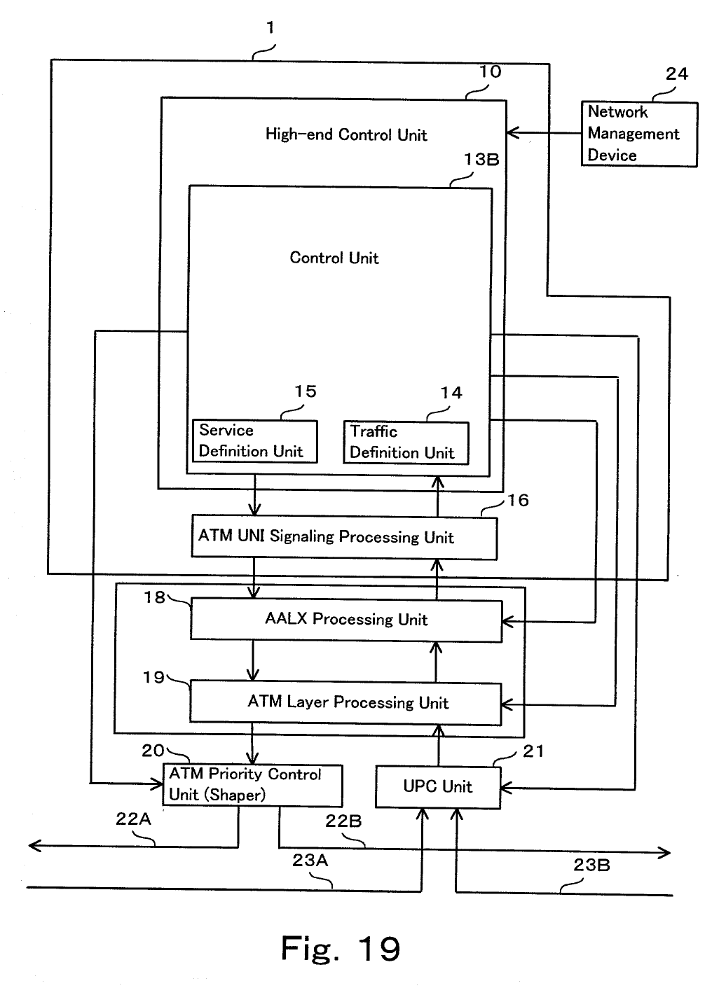

In the following description, we will describe a third preferred embodiment of the present invention. FIG. 15 is a block diagram that illustrates a example (1st example) of the present embodiment, and also FIG. 19 is a block diagram that illustrates another example (2nd example) of the present embodiment. As can be seen from FIG. 15, the system configuration of the third preferred embodiment (1st example) is different from that of the first embodiment because of the following points. The first point is that, in the system configuration of the present embodiment, the network management device 24 and the high-end control unit 10 are connected to each other without permitting the communication therebetween. The second point is that the control unit 3 of the present embodiment is provided as a control unit 13A only having the connection management portion 5.

As can be seen from FIG. 19, the system configuration of the third preferred embodiment (2st) is different from that of the first embodiment because of the following points. The first point is that, in the system configuration of the present embodiment, the TCP/UDP layer control unit 11 and the IP layer control unit 12 are not present. The second point is that, comparing with the control unit 13 of the first embodiment, the control unit (i.e., a traffic control unit) 13B of the present invention only comprises a traffic definition portion 14 and a service definition portion 15. The third point is that the control unit 13B is installed in the high-end control unit 10 in the present embodiment. The fourth point is that the LLC/SNAP layer control unit 17 is not present in the present embodiment. The fifth point is that the AAL X processing unit 18 and the ATM layer processing unit 19 are provided as an ATM switch unit 29 that acts as an ATM switching mechanism. The sixth point is that the ATM cell priority control unit 20 has a plurality of ATM cell sending-side logic lines 22A, 22B in the present embodiment. The seventh point is that the UPC unit 21 has a plurality of ATM cell receiving-side logic line 23A, 23B.

The ATM cell sending-side logic line 22A and the ATM cell receiving-side logic line 23A are used for the data communications to the ATM network or the ATM subscriber network. On the other hand, the ATM cell sending-side logic line 22B and the ATM cell receiving-side logic line 23B are used for the data communications to the subscriber terminal. The ATM cell sending-side logic line 22 shown in FIG. 15 and the ATM cell receiving-side logic line 23B shown in FIG. 19 are connected to each other. On the other hand, the ATM cell receiving-side logic line shown in FIG. 15 and the ATM cell sending-line logic line 22B are connected to each other. The communication control system of the present embodiment can be operated as a combination of the system configuration shown in FIG. 15 and the system configuration shown in FIG. 19.

Next, the behavior of the third embodiment (1st example) of the present invention will be described. The high-end control unit 10 passes the sending data to the TCP/UFP layer control unit 11. The TCP/UDP layer control unit 11 constructs the TCP packet 100 or the UDP packet 110 and then transmits the packet 100 or 110 to the IP layer control unit 12. The IP layer control unit 12 constructs the IPv4 packet 200 or the IPv6 packet 210 and then transmits the packet 200 or 210 to the control unit 13A. The control unit 13A receives the IP packet 220.

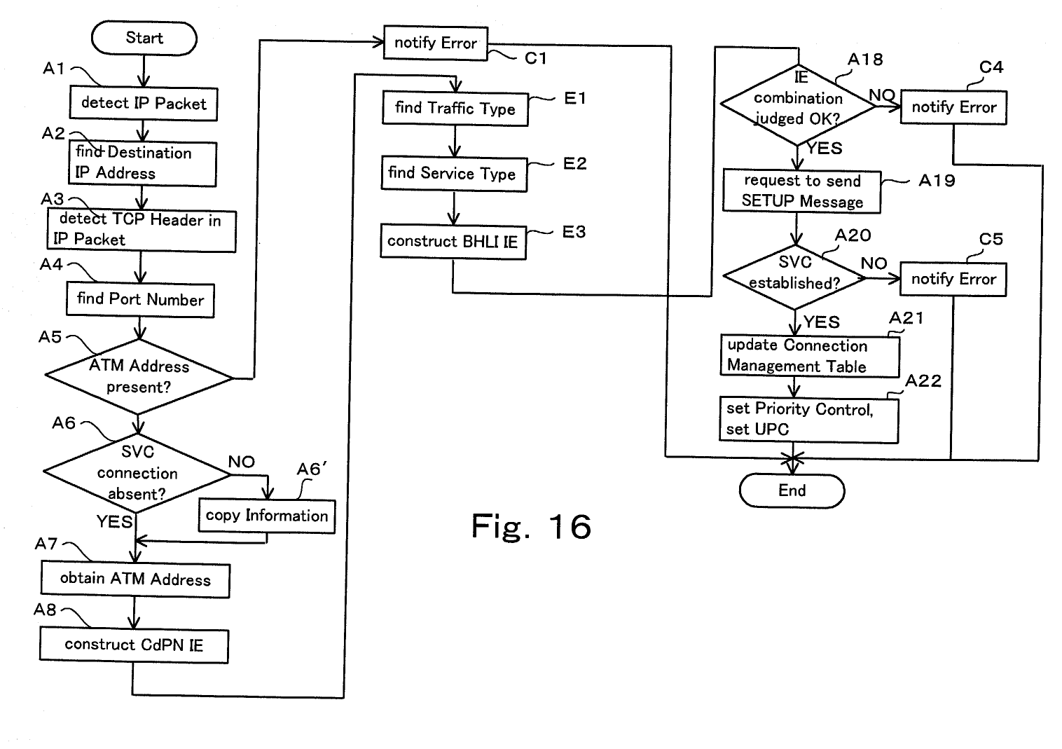

FIG. 16 is a flow chart that illustrates the operation of the system in accordance with the third preferred embodiment (1st example). In the figure, the actions of the control unit 13A in the steps A1 to A8, the steps A18 to A22, and the steps C1, C4, and C5 correspond to the actions of the first embodiment in the steps A1 to A8, the steps 18 to A22, and the steps C1, C4, and C5 of FIG. 9. Thus, the description concerned about those steps will be omitted.

In the third embodiment (No. 1), the control unit 13A recognizes Type of Service 203 of the IPv4 packet header 201 and Traffic Class 213 of the IPv6 packet header 211 configured in the IP packet header portion 221 of the IP packet 220 (Step E1). Next, the service type is recognized from the TCP/UDP terminal port number 61 of the TCP/UDP port number that is recognized at the step A4 (Step E2). Then, Broadband High Layer Information IE, which is one of the characteristics of the present embodiment, is constructed with reference to the traffic type recognized at the step E2 and the TCP/UDP port number that indicates the traffic type recognized at the step E1 (Step E3).

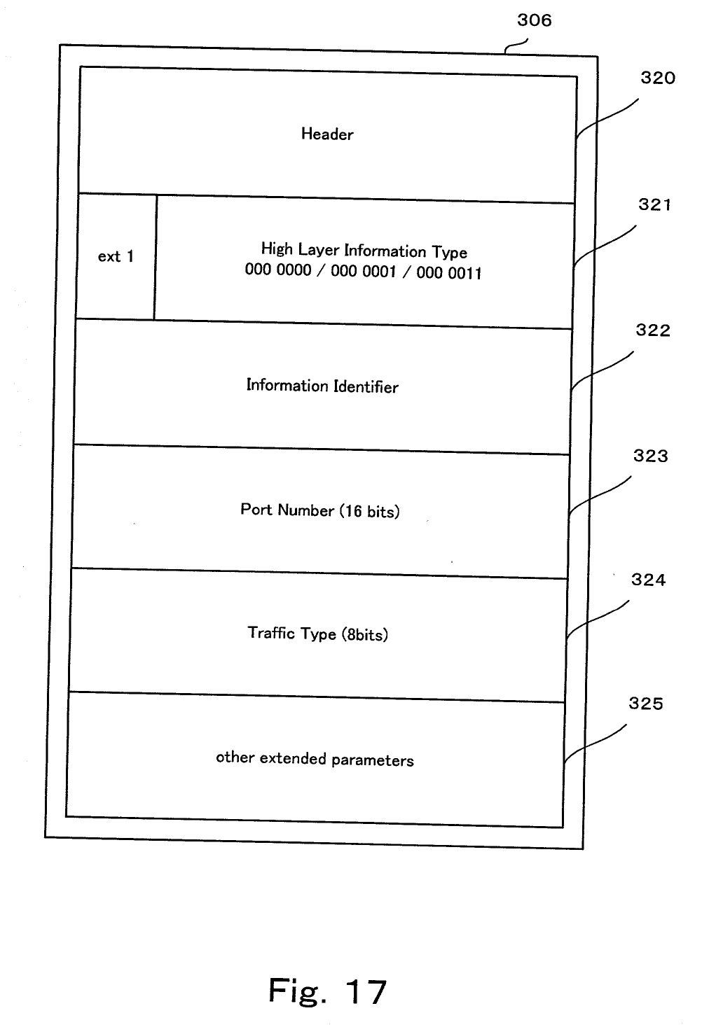

FIG. 17 is a schematic diagram of the Broadband High Layer Information IE constructed by the system of the third preferred embodiment (1st example) of the present invention. The control unit 13A constructs BHLI IE 306 based on UNI 3.1 or UNI 4.0. The BHLI IE 306 comprises a header 320, a parameter defined by UNI 3.1 or UNI 4.0, an information identifier 322 defined by the control unit A, a port number 323, a traffic type 324, and other extended parameter 325.

In the present embodiment, it is noted that the information identifier 322, the port number 323, and the traffic type 324, which are not defined by BHLI IE of UNI 3.1 or UNI 4.0. The term “not defined” means that the user is able to define at one's pleasure in UNI 3.1 or UNI 4.0. Thus, the information identifier 322 may be required for the port number 322 and the traffic type 324, which are defined by the user at one's disposal. The control unit 13A sets the TCP terminal port number 104 or the UDP terminal port number 114 recognized at the step E2 to the port number 323. Also, the control unit 13A sets Type of Service 203 of the IPv4 packet header 201 configured in the IP packet header portion 221 of the IP packet 220 recognized at the step E2. Alternatively, it sets Traffic Class 213 of the IPv6 packet header 211 to the traffic type 324.

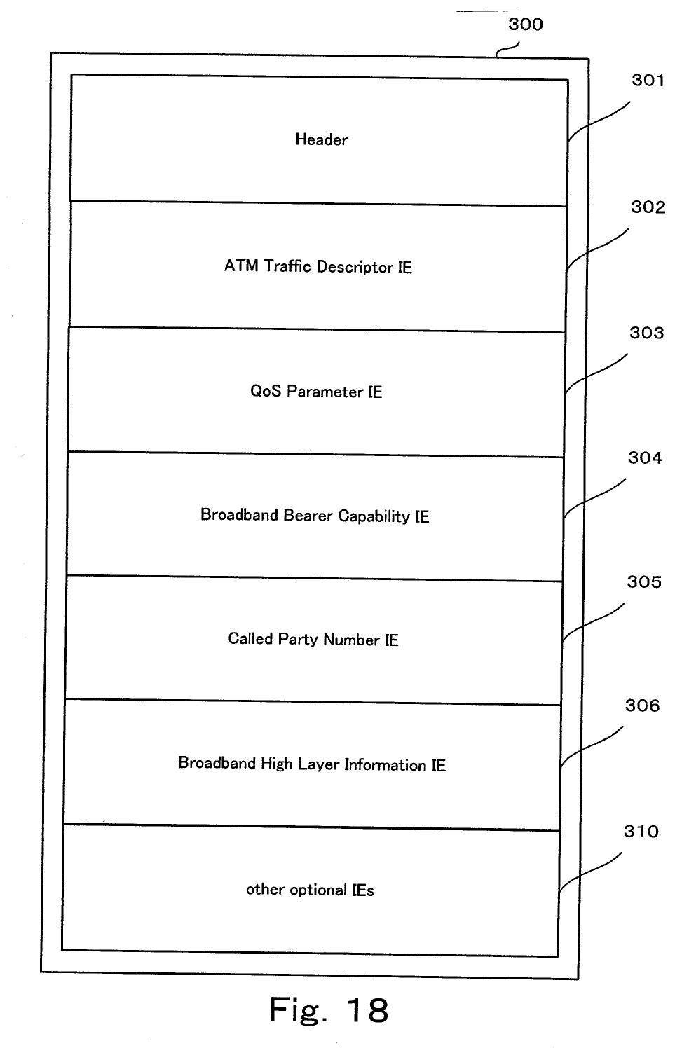

FIG. 18 is an explanation diagram that illustrates another SETUP message that is defined by UNI 3.1 or UNI 4.0 to be used in the present invention. The control unit 13A constructs the SETUP message (see FIG. 18) 300. The SETUP message 300 comprises a header 301, an ATM Traffic Descriptor IE 302 constructed as an initial value by the control unit 13, a Broadband Bearer Capability IE 304, a QoS Parameter IE 303, a Called Party Number IE 305 constructed at the step A8, a Broadband High Layer Information IE 306, and the other optional IE(s) 3.10. The control unit 13A requests the sending of the SETUP message (see FIG. 18) constructed against the ATM UNI signaling processing unit 16 (Step A19). In the step A19, the ATM UNI signaling processing unit 16 receiving the request of sending the SETUP message 300 performs the ATM UNI signaling processing to attempt the establishment of the SVC connection.

Secondary, we will describe the operation of a communication control system as another example of the third preferred embodiment of the present invention. The system of the present embodiment (2nd example) is designed so that the ATM cell including the SETUP message information constructed by the system shown in FIG. 15 is received from the ATM cell receiving-side logic line 23B. The SETUP message is mapped in the ATM cell of VPI/VCI=0/5 based on the definition of UNI 3.1 or UNI 4.0. The ATM layer processing portion 19 of the ATM switch unit 29 references the value of VPI/VCI=0/5 indicated by the ATM cell. Then, it recognizes that such a cell is an ATM cell for ATM UNI signaling message, followed by transmitting the ATM cell to the AAL X processing unit 18. The AAL X processing unit 18 reconstructs the ATM UNI signaling message (see FIG. 18) from the ATM cell and then transmits it to the ATM UNI signaling processing unit 16. The ATM UNI signaling processing unit 16 performs the process defined by the protocol with respect to the SETUP message and then transmits it to the high-end control unit 10. The high-end control unit 10 activates the control unit 13B after receiving the SETUP message.

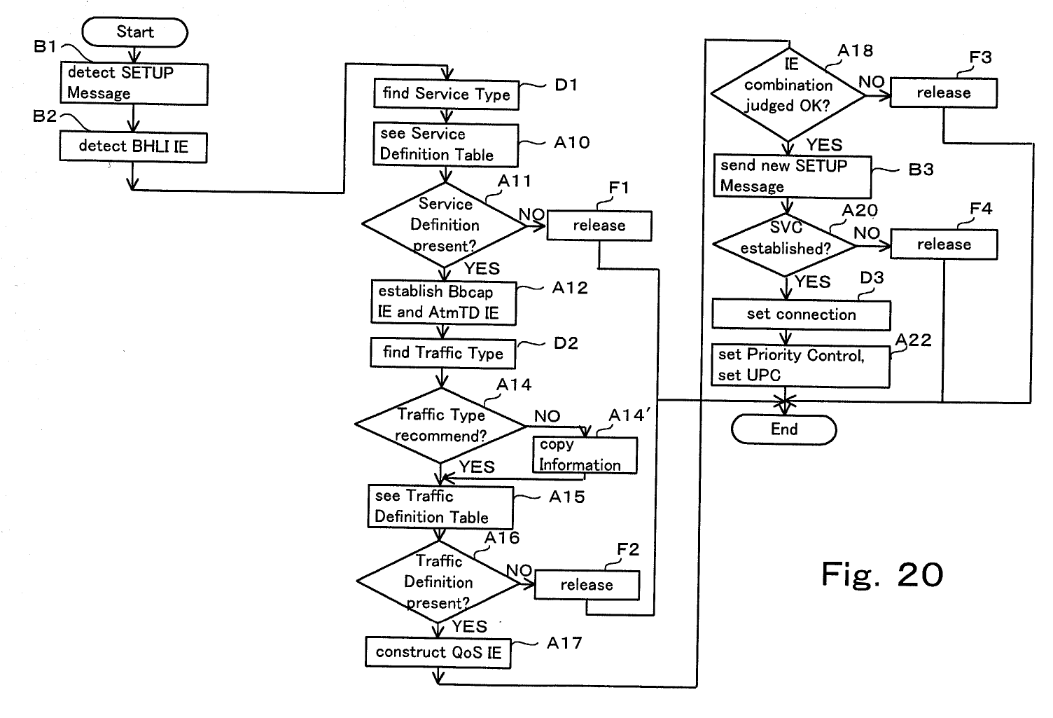

FIG. 20 is a flow chart that illustrates the operation of the system of the third preferred embodiment (2nd example). In this figure, the actions of the control unit 13B at the steps A10, A11, A12, A14, A14′, A15, A16, A17, A18, A20, and A22 correspond to the actions of the first embodiment at the steps of A10, A11, A12, A14, A14′, A15, A16, A17, A18, A20, and A22 in FIG. 9. Therefore, the description concerned about those steps will be omitted in this embodiment.

The control unit 13B detects the SETUP message received by the high-end control unit 10 (Step B1). Then, the BHLI IE 306 of the SETUP message is detected (Step B2). Subsequently, the control unit 13B recognizes a port number (323 in FIG. 17) contained in the BHLI IE 306 (Step D1). Next, the steps A10 and all are executed. If the control unit 13B, at the step A11, determines that there is no traffic type in the traffic definition table 50, RELEAE COMLETE message defined by UNI 3.1 or UNI 4.0 is constructed for the purpose of notifying the cancellation of the ATM UNI signaling processing to the sending side of the SETUP message. Then, it is transmitted from the ATM cell sending-side logic line 22B through the ATM switch unit 29 and the ATM cell priority control unit 20, resulting in the termination of the process (Step F1). Subsequently, the control unit 13B executes the step A12, and then recognizes the traffic type (324 in FIG. 17) contained in the BHLI IE 306 (Step D2).

Then, the steps A14 and A15 are executed, or alternatively the steps A14′ and 15 are executed. Furthermore, the control unit 13B executes the step A16. In the step A16, if it is determined that the traffic type is not present in the traffic definition table 60, RELEAE COMPLETE message defined by UNI 3.1 or UNI 4.0 is constructed for the purpose of notifying the cancellation of ATM UNI signaling processing to the sending side of the SETUP message. Then, it is transmitted from the ATM cell sending-side logic line 22B through the ATM switch unit 29 and the ATM cell priority control unit 20, resulting in the termination of the process (Step F2). Subsequently, the control unit 13B executes the step A17, and then the judgement on a newly constructed combination of QoS IE, Bbcap IE, and AtmTD IE is performed (Step A18). In this case, if the combination of QoS IE, Bbcap IE, and AtmTD IE is inadequate, the same procedures are executed at the steps F1 and F2 and then the process is terminated (Step F3).

The SETUP message constructed by the process shown in FIG. 20 becomes the SETUP message with the removal of BHLI IE 306 from the SETUP message of FIG. 18. In this case, the BHLI IE 306 is processed between the systems of the two exemplified systems (1st and 2nd) of the third preferred embodiment. Next, the control unit 13BB sends a newly reconstructed SETUP message (FIG. 13) to the ATM network or the ATM subscriber network by the ATM cell sending-side logic line 22A through the ATM switch unit 29 and the ATM cell priority control unit 20 (Step B3). The system shown in FIG. 1 and the system shown in FIG. 19 perform the transmission/reception of ATM UNI signaling messages (actually, ATM cells on which these messages are mapped) using the ATM cell sending-side logic lines 22, 22A, 22B and the ATM receiving-side logic lines 23, 23A, 23B, respectively. Then, the protocol procedures are performed to establish SVC connections, respectively.

The operation of the system in accordance with the third embodiment (1st example) of the present invention, as can be seen from FIG. 16, performs the steps A20, A21, and A22 when the SVC connection is established and then the process is terminated. On the other hand, if the SVC connection is failed, the steps from A20 to C5 are carried out and then the process is terminated. Regarding the operation of the third preferred embodiment (2nd example) of the present invention, as can be seen from FIG. 20, if the SVC connection is established at the step A20, the connection is set to the ATM switch unit 29 (Step D3) and the step A22 is executed to terminate the process. If the establishment of SVC connection is failed, the step F4, which is the same process as those of F1, F2, and F3, is executed and then the process is terminated. The connection information and the connection management to be configured by the control unit 13B with respect to the step D3 in FIG. 19 are technologies of ATM switch control, so that the operations and functions thereof can be easily understand by a person skilled in the art. Thus, the explanation thereof will be omitted in the following description.

In the prior art technologies, the BHLI IE must be processed between EtoEs that establish the SVC connection on the basis of UNI 3.1 or UNI 4.0. According to the present embodiment, however, the BHLI IE is processed between the system shown in FIG. 15 and the system shown in FIG. 15 by their respective actions, so that it becomes possible to use the BHLI IE for the transmissions of the port number 322 and the destination IP address 323.

### Fourth Preferred Embodiment

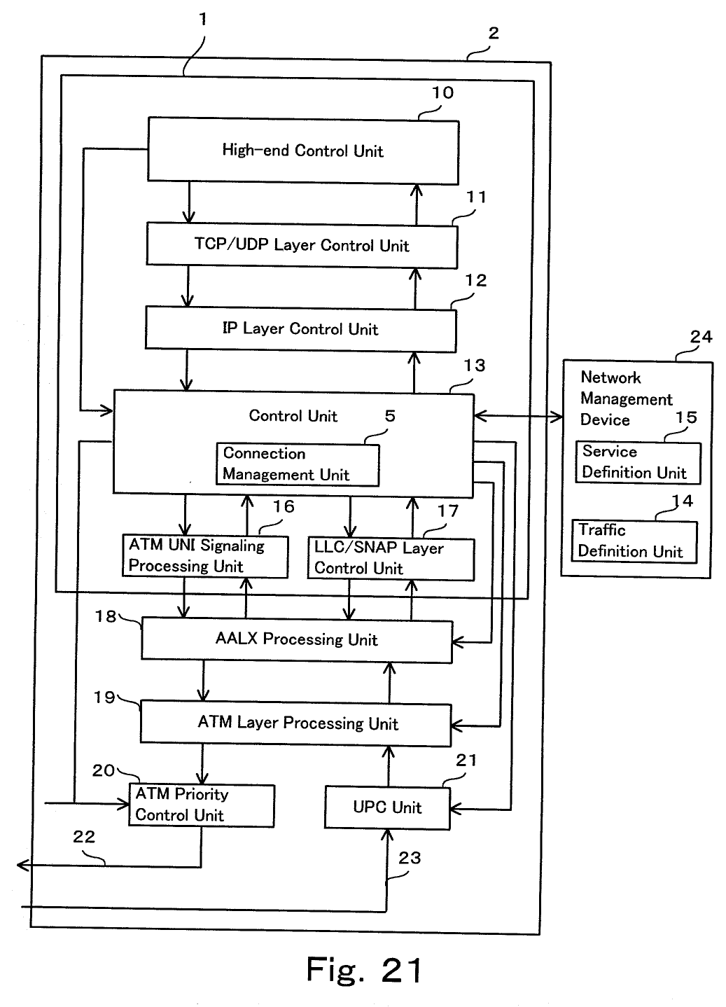

Next, we will describe a fourth preferred embodiment of the present invention. FIG. 21 is a block diagram that illustrates the present embodiment. As shown in FIG. 21, a communication control system of the present embodiment is different from that of the first embodiment because of the following points. The first point is that, in the system configuration of the present embodiment, the network management device 24 comprises a service definition portion 15 and a traffic definition portion 15. The second point is that, in the system configuration of the present embodiment, the communication control system 2 comprises all of the following components: a high-end control unit 10, a TCP/UDP layer control unit 11, an IP layer control unit 12, a control unit 13, an ATM UNI signaling processing unit 16, an LLC/SNAP layer processing unit 17, an AAL X processing nit 18, an ATM layer processing unit 19, an ATM cell priority control unit 20, and an UPC unit 21.

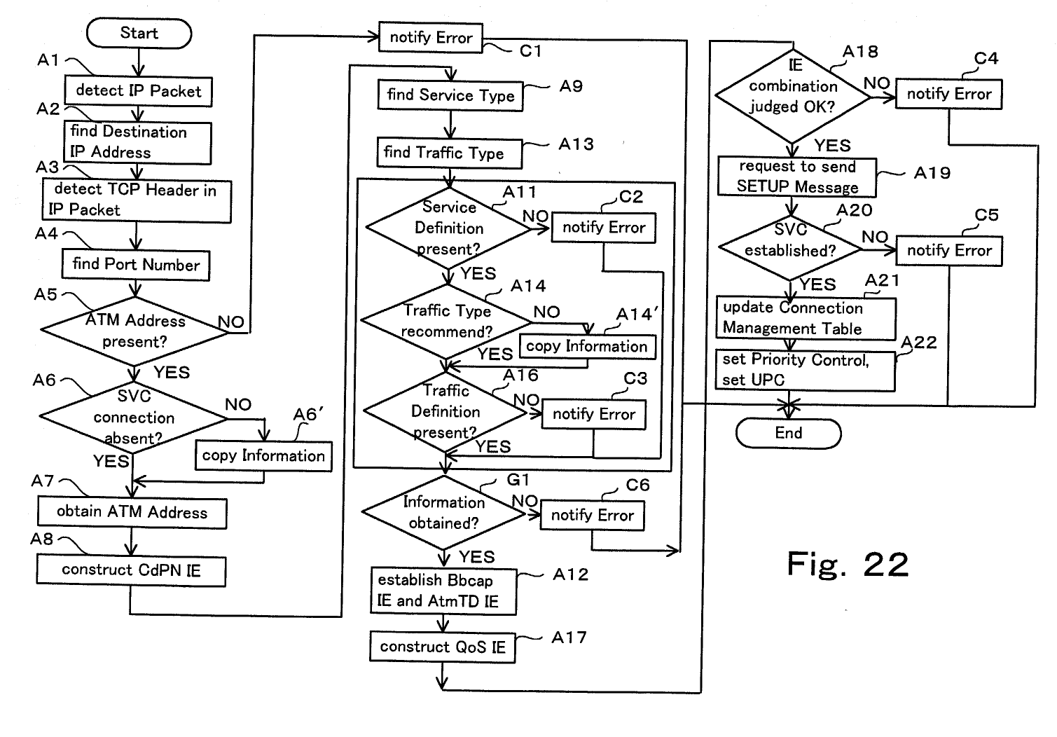

Next, the operation of the system of the fourth embodiment will be described below. The operation of the system of the present embodiment is remarkably similar that of the first embodiment, so that only the different points will be described. In this embodiment, the sequence of the steps in the flow chart is different from that of the flow chart shown in FIG. 9. In this embodiment, the step A13 is executed after performing the process at the step A9. Here, the control unit 13 make an inquiry about the service and the traffic type recognized by the network management device 24. The process performed by the network management device 24 is the step N1 in FIG. 22. In the step N1, the steps A11, A14, and A15 are performed, sequentially. If all of the steps A11, A14, and A15 is successfully completed, the information for executing the steps A12 and A15 is notified to the inquired control unit 13. Then, the control unit 13 that receives the information (Step G1) continues the steps A12 and A17. In the steps A11 and A16, on the other hand, if an error is caused, such an error is notified to the inquired control unit 13 by means of an error handling of the steps C2 and C3. The control unit 13 that receives the error notification executes the error handling and then the process is terminated.

In this embodiment, therefore, the control unit 13 and the network management device 24 are cooperated together to perform the process indicated in FIG. 22, so that the sequence of the steps is changed. For performing the processing flow by the control unit 13 together with the network management device 24, the process may be distributed processing, taking much of the load off these components. In addition, the network management device 24 comprises the service definition portion 15 and the traffic definition portion 14, so that the table information stored in these portions may be automatically updated. It may also contribute to the decrease in the occupied amount of memory.

### Fifth Preferred Embodiment

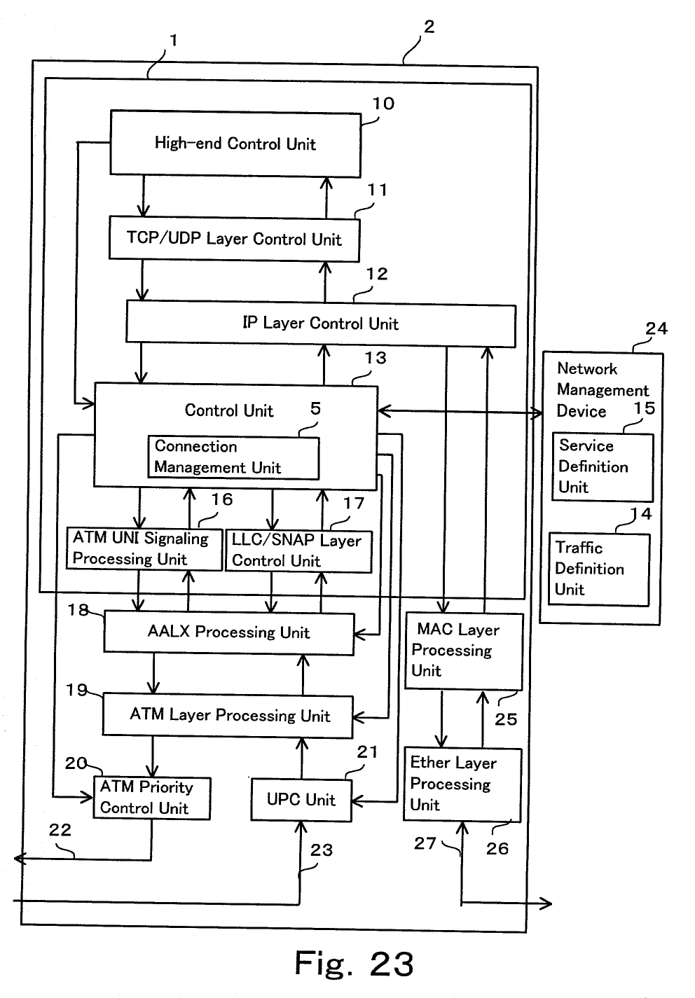

Next, we will describe a fifth preferred embodiment of the present invention. FIG. 23 is a block diagram that illustrates a communication control system the present embodiment. As shown in FIG. 23, a communication control system of the present embodiment is different from that of the second embodiment because of the following points. The first point is that, in the system configuration of the present embodiment, the network management device 24 comprises a service definition portion 15 and a traffic definition portion 14. The second point is that, in the system configuration of the present embodiment, the communication control system 2 comprises all of the following components: a high-end control unit 10, a TCP/UDP layer control unit 11, an IP layer control unit 12, a control unit 13, an ATM UNI signaling processing unit 16, an LLC/SNAP layer processing unit 17, an AAL X processing nit 18, an ATM layer processing unit 19, an ATM cell priority control unit 20, an UPC unit 21, a MAC layer processing unit 25, and an Ether layer processing unit 266.

The operation of the system of the present embodiment is the same as that of the fourth embodiment with reference to FIG. 22, so that the explanation thereof will be omitted in the following description. In this embodiment, the same effects as those of the second and fourth embodiments can be obtained.

### Sixth Preferred Embodiment

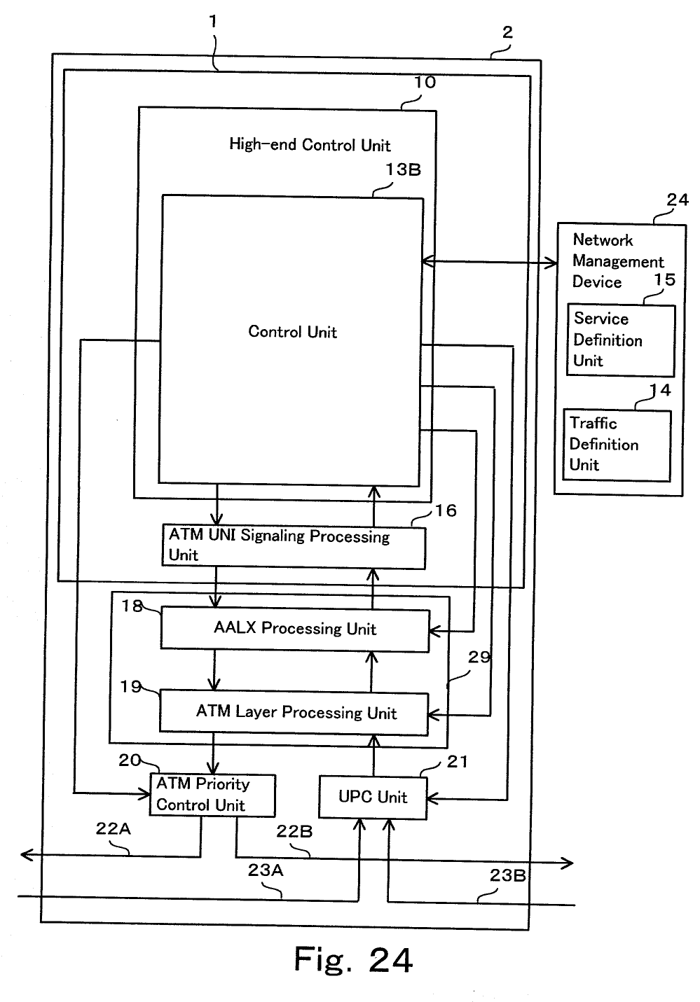

Next, we will describe a sixth preferred embodiment of the present invention. FIG. 24 is a block diagram that illustrates a communication control system the present embodiment. In this embodiment, as can be seen from FIG. 24, the communication control system of the present embodiment is different from that of the third embodiment (2nd example) because of the following points. The first point is that, in the system configuration of the present embodiment, the network management device 224 comprises a service definition portion 15 and a traffic definition portion 14. The second point is that, in the system configuration of the present embodiment, the communication control system 2 comprises all of the following components: a high-end control unit 10, a control unit 13, an ATM UNI signaling processing unit 16, an AAL X processing nit 18, an ATM layer processing unit 19, an ATM cell priority control unit 20, and an UPC unit 21.

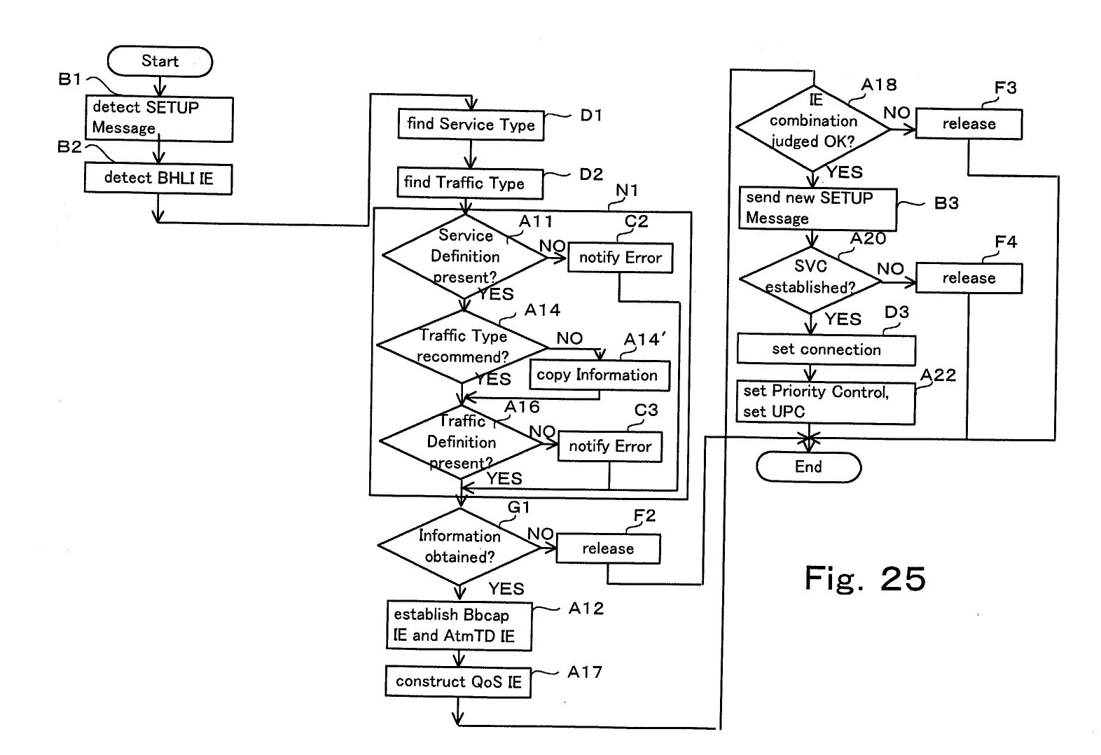

The operation of the system of the present embodiment will be described below. In this embodiment, just as in the case of the flow chart in FIG. 22 that shows the operation of the fourth embodiment, the control unit 13 and the network management device 24 are cooperated together to perform the process indicated in FIG. 22, so that the sequence of the steps is changed. In this embodiment, the same steps as those of the flow chart in FIG. 20 for the operation of the third embodiment (2nd example) are performed, except the step G1. The step N1 in FIG. 25 is the process to be executed by the network management device 24. The process is executed depending to the response from the network management device 24. The system of the present embodiment can be operated by connecting with the system described in the third preferred embodiment (1st example).

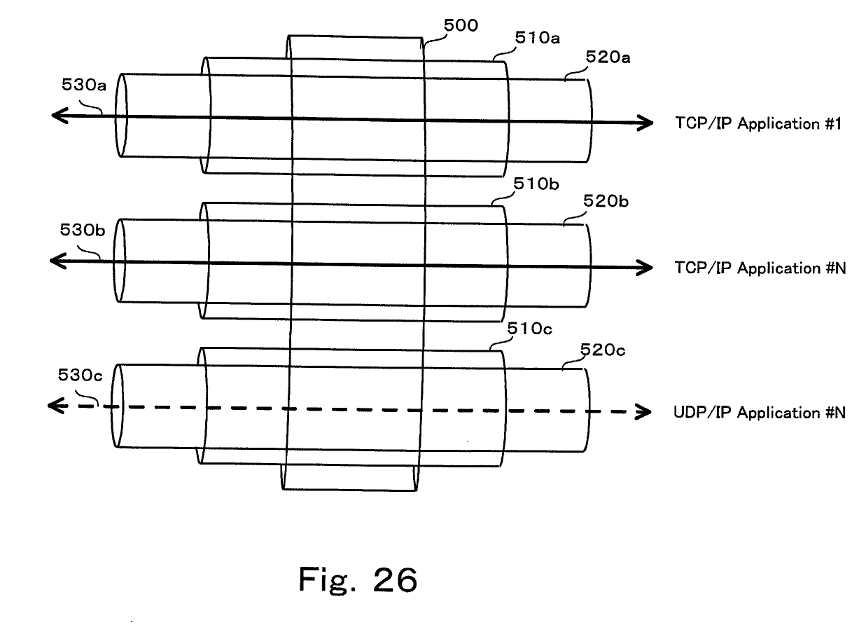

FIG. 26 is a logic diagram that illustrates IP over ATM connection that can be established by a combination of: the construction shown in FIG. 3 and the action shown in FIG. 9 as the first embodiment; the construction shown in FIGS. 15 and 19 and the action shown in FIGS. 16 and 20 as the second embodiment; the construction shown in FIG. 21 and the action shown in FIG. 22 as the fourth embodiment; the construction shown in FIG. 23 and the action shown in FIG. 21 as the fourth embodiment; the construction shown in FIG. 23 and the action shown in FIG. 21 as the fifth embodiment; and the construction shown in FIG. 15 as the third embodiment and FIG. 24 as the sixth embodiment and the action shown in FIG. 16 and FIG. 25.

A plurality of SVC connections 510a, 510b, and 510c is established as service units in the inside of physical connection (line) 500 physical connection). The SVC connections 510a, 510b, and 510c have their respective IP layer (Network layer) connections 520a, 520b, and 520c. In addition, TCP connections 530a, 530b and UDP connections 530c are present n the insides of the respective IP layer connections 520a, 520b, and 520c. In the connection logic diagram shown in FIG. 6, the connection management table 70 held by the connection control unit 5 of the control unit 13 occupy one SVC connection per one service of one TCP or UDP/IP application so that the TCP/UDP port, the IP address, the destination ATM address, the VP/UDP ort of the SVC connection are provided at the ratio of 1:1:1:1.

### Concrete Examples

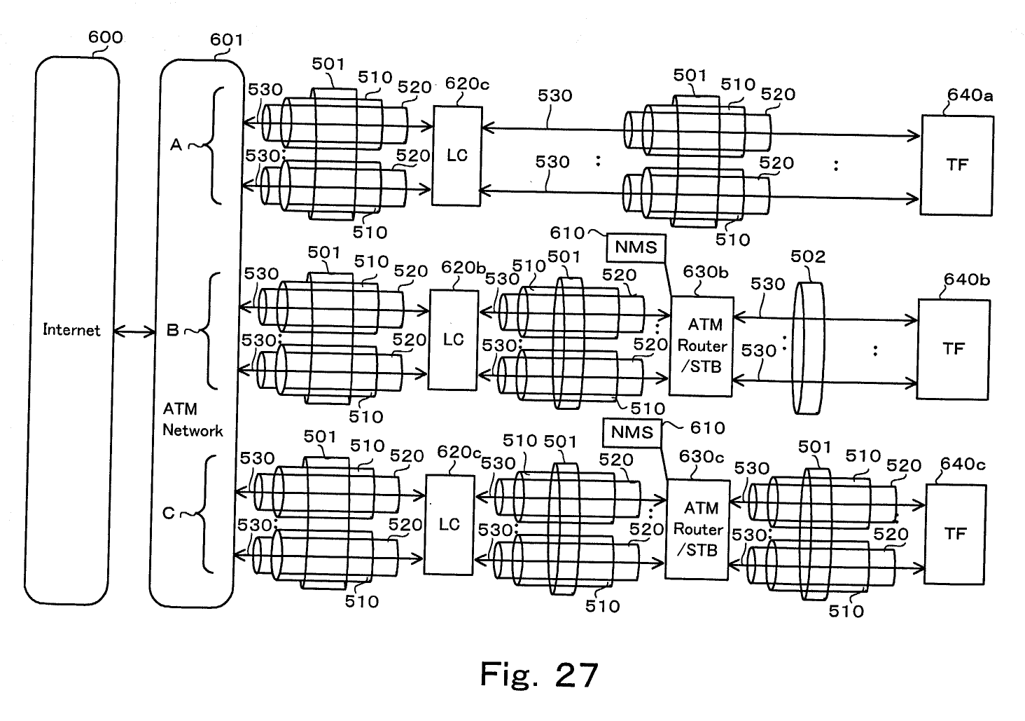

Next, we will describe a concrete example in the following description. FIG. 27 is a schematic diagram that illustrates a network configuration. In the figure, the portion indicated by the letter “A” is a logic diagram that illustrates an example IP over ATM connection established in an example of the network comprised of: subscriber terminals of the first or fourth embodiments, the ATM network, and the Internet.

The “A” portion of FIG. 27 comprises: the Internet 600, the ATM network 601, the ATM subscriber line concentration device 620a, and the subscriber terminal 640a having the system of the first or fourth embodiment of the present invention. A physical line is provided as an ATM (light, electricity) physical connection 5001 between the ATM network 601 and the ATM subscriber line collection device 620a. Also, a physical line is provided as an ATM (light, electricity) physical connection 501 between the ATM subscriber line collection device 620a and the subscriber terminal 640a. In this case, the ATM subscriber line collection device 630a becomes a device that constructs the ATM subscriber network. The network management device 24 shown in FIG. 3 or FIG. 6 is provided as the Network Management System (MMS) 610 and connected with the subscriber terminal having the system of the first or fourth embodiment. The SVC connection 510 can be established in the ATM (light, electricity) physical connection 501 between the ATM network 601 and the ATM subscriber line collection device 620a by executing the process shown in FIG. 22 at the subscriber terminal having the system of FIG. 21 or the process shown in FIG. 9 at the subscriber terminal having the system of FIG. 3.

The SVC connection 510 comprises the IP layer (network layer) connection 520. In addition, the TCP/UDP connection 530 is present in the IP layer (network) connection 520 to provide a connection logic configuration. On the other hand, the SVC connection 510 is established in the ATM (light, electricity) physical connection 501 between the ATM subscriber line collection device 620a and the subscriber terminal 640a. The SVC connection 510 comprises the IP layer (network layer) connection 520. In addition, the TCP/UDP connection 530

In addition, the TCP/UDP connection 530 is present in the IP layer (network) connection 520 to provide a connection logic configuration.

The “B” portion of FIG. 27 is a logic diagram that illustrates an example of IP over ATM connection to be established, as an example, in the network to be constructed of ATM router or STB having the system of the second or fifth embodiment of the present invention, subscriber terminal, ATM subscriber line collection device, ATM network, and the Internet.

The “B” portion of FIG. 27 comprises the Internet 600, the ATM network 601, the ATM subscriber line collection device 620b, ATM router/STB 630b having the system of the second or fifth embodiments of the present invention, and the subscriber terminal 640b. An ATM (light, electricity) physical connection 501 is provided as a physical connection between the ATM network 601 and the ATM subscriber line collection device 620b, an ATM (light, electricity) physical connection 501 is provided as a physical line between the ATM subscriber line collection device 620b and the ATM router/STB 630bb, and an Ether physical connection 502 is provided as a physical line between the ATM router/STB 630b and the subscriber terminal 640b.

The network management device 24 shown in FIG. 14 or FIG. 26 is provided as the Network Management System (NMS) 610 and connected with the ATM router/STB 630b having the system of the second or fifth embodiment.

The process indicated in FIG. 9 or FIG. 10 is executed at the ATM router/STB 630b, so that the SVC connection 510 is established on the ATM (light, electricity) physical connection 501 between the ATM network 601 and the ATM subscriber line collection device 620a.

The SVC connection 510 comprises the IP layer (network layer) connection 520. In addition, the TCP/UDP connection 530 is present in the IP layer (network) connection 520 to provide a connection logic configuration. On the other hand, the SVC connection 510 is established in the ATM (light, electricity) physical connection 501 between the ATM subscriber line collection device 620b and the ATM router/STB 630b. The SVC connection 510 comprises the IP layer (network layer) connection 520. In addition, the TCP/UDP connection 530 is present in the IP layer (network) connection 520 to provide a connection logic configuration. Furthermore, the Ether physical connection 502 between the ATM router/STB 630b and the subscriber terminal 640b becomes a connection logic configuration in which the conventional TCP/IP connection 530 is present.

The “C” portion of FIG. 27 is a logic diagram that illustrates an example of IP over ATM connection to be established, as an example, in the network to be constructed of ATM router or STB having the system of the third (2nd example) or sixth embodiment of the present invention, subscriber terminal having the system of the third embodiment (1st example), ATM subscriber line collection device, ATM network, and the Internet.

The “C” portion of FIG. 27 comprises the Internet 600, the ATM network 601, the ATM subscriber line collection device 620c. ATM router/STB 630c. and the subscriber terminal 640c. An ATM (light, electricity) physical connection 501 is provided as a physical connection between the ATM network 601 and the ATM subscriber line collection device 620c. and an ATM (light, electricity) physical connection 501 is provided as a physical line between the ATM subscriber line collection device 620c and the ATM router/STB 630c. and an ATM (light, electricity) physical connection 501 is provided as a physical line between the ATM router/STB 630b and the subscriber terminal 640c.

The network management device 24 shown in FIG. 14 or FIG. 26 is provided as the Network Management System (NMS) 610 and connected with the ATM router/STB 630c.

The process indicated in FIG. 16 is executed by the subscriber terminal 640c having the system of the FIG. 15. The process shown in FIG. 20 or FIG. 16 is executed by the ATM router/STB 630c having the system shown in FIG. 19. Also, the process shown in FIG. 25 is executed by the ATM router/STB 630c having the system shown in FIG. 24. Therefore, the SVC connection 510 is established on the ATM (light, electricity) physical connection 501. The SVC connection 510 comprises the IP layer (network layer) connection 520. In addition, the TCP/UDP connection 530 is present in the IP layer (network) connection 520 to provide a connection logic configuration.

On the other hand, the SVC connection 510 is established in the ATM (light, electricity) physical connection 501 between the ATM subscriber line collection device 620c and the ATM router/STB 630c having the system shown in FIG.19 or FIG. 24. The SVC connection 510 comprises the IP layer (network layer) connection 520. In addition, the TCP/UDP connection 530 is present in the IP layer (network) connection 520 to provide a connection logic configuration. Furthermore, the SVC connection is established on the ATM (light, electricity) physical connection 501 between the ATM router/STB 630c having the system of FIG. 19 or FIG. 24 and the subscriber terminal 640c. The SVC connection 510 comprises the IP layer (network layer) connection 520. In addition, the TCP/UDP connection 530 is present in the IP layer (network) connection 520 to provide a connection logic configuration.

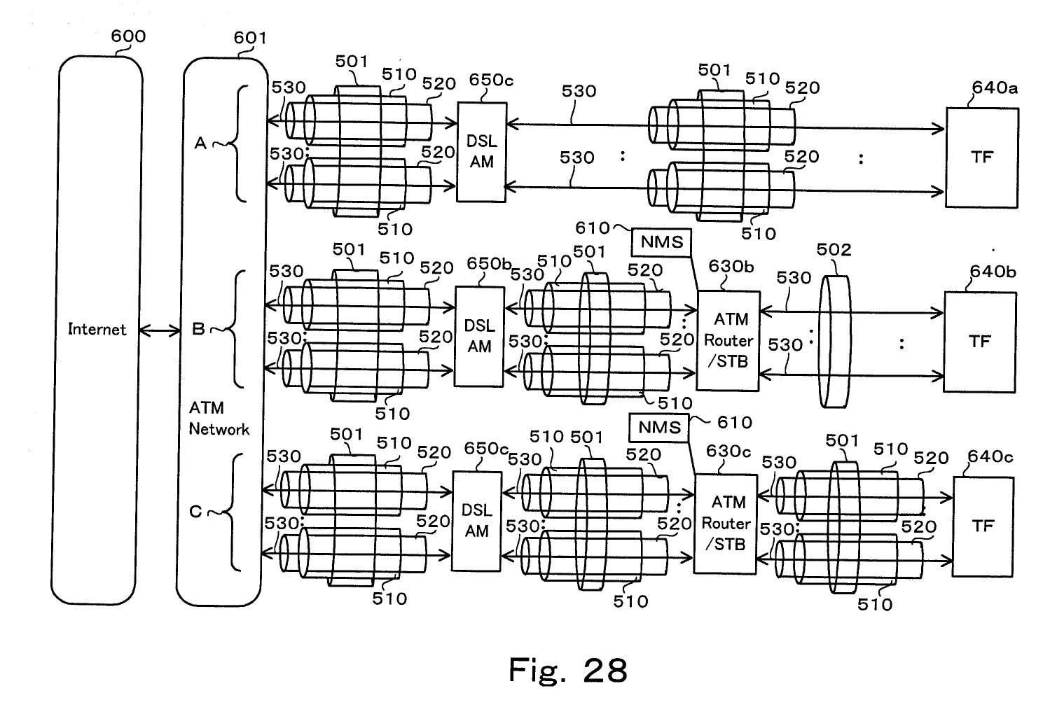

Next, a second concrete example will be described. FIG. 28 is a schematic diagram that illustrates the network configuration in accordance with the second embodiment of the present invention. In FIG. 28, the portion indicated by the character “A” is a logic diagram that illustrates an example of IP over ATM connection to be established, as an example, in the network comprising: a subscriber terminal having the system of the first or fourth embodiment, a digital subscriber line access multiplexer (DSLAM), an ATM network, and the Internet. The portion “0” in FIG. 28 comprises the internet 600, the ATM network 601, the DSLAM 650a, and the subscriber terminal 640a having the device of the first or fourth embodiment of the present invention. The ATM (light, electricity) physical connection 501 is provided as a physical line between the ATM network 601 and the DSLAM 650a, the ATM over xDSL connection 503 is provided as a physical line between the DSLAM 650a and the subscriber terminal 640a. The term “xDSL” is a generic name of Asymmetric DSL (Digital subscriber Line), High-bit-rate DSL, Rate-Adaptive DSL, Symmetric DSL, Very-high-bit-rate DSL, and so on.

The network management device 24 of FIG. 3 or FIG. 6 is provided as Network Management System (NMS) to be connected to the subscriber terminal 640a having the system of the first or fourth embodiment. The SVC connection 510 is established on the ATM (light, electricity) physical connection 501 between the ATM network 601 and the DSLAM 650a by executing the process shown in FIG. 9 at the subscriber terminal 64 having the system shown in FIG. 3 or executing the process shown in FIG. 22 at the subscriber terminal 640a having the system of FIG. 21. The SVC connection 510 comprises the IP layer (network layer) connection 520. In addition, the TCP/UDP connection 530 is present in the IP layer (network) connection 520 to provide a connection logic configuration. On the other hand, the SVC connection 510 is established on the ATM over xDSL connection 502 between the ATM subscriber terminal 640a and the DSLAM 650a. The SVC connection 510 comprises the IP layer (network layer) connection 520. In addition, the TCP/UDP connection 530 is present in the IP layer (network) connection 520 to provide a connection logic configuration.

In FIG. 28, the portion indicated by the character “B” is a logic diagram that illustrates an example of IP over ATM connection to be established, as an example, in the network comprising: an ADSL router or STB having the system of the second or fifth embodiment, a subscriber terminal, a Digital Subscriber Access Multiplexer (DSLAM), an ATM network, and the Internet. The portion “B” in FIG. 28 comprises the Internet 600, the ATM network 601, the DSLAM 650b, the ADSL router/STB 630b having the system of the second or fifth embodiment, and the subscriber terminal 640b. The ATM (light, electricity) physical connection 501 is provided as a physical line between the ATM network 601 and the DSLAM 650b. The ATM over xDSL connection 503 is provided as a physical line between the DSLAM 650b and the subscriber terminal 640b. The term “xDSL” is a generic name of Asymmetric DSL (Digital subscriber Line), High-bit-rate DSL, Rate-Adaptive DSL, Symmetric DSL, Very-high-bit-rate DSL, and so on. In addition, the Ether physical connection 502 is provided as a physical line between the ADSL router/STB 630b and the subscriber terminal 640b. In this case, the DSLAM 650b and the ADSL router/STB 630b may be provided as devices that make up the ATM subscriber network.

The network management device 24 of FIG. 14 or FIG. 26 is provided as Network Management System (NMS) to be connected to the ADSL router/STB 630b having the system of the second or fourth embodiment.

The SVC connection 510 is established on the ATM (light, electricity) physical connection 501 between the ATM network 601 and the DSLAM 650b by executing the process shown in FIG. 9 or 25 at the ATM router/STB 630b having the device of FIG. 14 or FIG. 23. The SVC connection 510 comprises the IP layer (network layer) connection 520. In addition, the TCP/UDP connection 530 is present in the IP layer (network) connection 520 to provide a connection logic configuration. On the other hand, the SVC connection 510 is established on the ATM over xDSL connection 502 between the ATM subscriber terminal 640a and the DSLAM 650b. The SVC connection 510 comprises the IP layer (network layer) connection 520. In addition, the TCP/UDP connection 530 is present in the IP layer (network) connection 520 to provide a connection logic configuration.

On the other hand, the SVC connection 510 is established on the ATM over xDSL connection 503 between the DSLAM 650b and the ADSL router/STB 630b having the system of the second embodiment. The SVC connection 510 comprises the IP layer (network layer) connection 520. In addition, the TCP/UDP connection 530 is present in the IP layer (network) connection 520 to provide a connection logic configuration.

Furthermore, the Ether physical connection 502 is provided as a physical line between the ADSL router/STB 630b and the subscriber terminal 640b. The Ether physical connection 502 may be of a connection logic configuration that comprises the conventional TCP/IP connection 530.

In FIG. 28, the portion indicated by the character “C” is a logic diagram that illustrates an example of IP over ATM connection to be established, as an example, in the network comprising: an ATM router or STB having the system of the third embodiment (2nd example) or the sixth embodiment, a subscriber terminal having the system of the third embodiment (1st example), a DSLAM, an ATM network, and the Internet. The portion “C” in FIG. 28 comprises: the Internet 600, the ATM network 601, the DSLAM 650c, the ADSL router/STB 630c having the system of the third embodiment (2nd example) or the sixth embodiment, and the subscriber terminal 640c having the system of the third embodiment (1st example).

ATM (light, electricity) physical connection 501 is provided as a physical line between the ATM network 601 and the DSLAM 650. Also, the ATM over xDSL connection 503 is provided as a physical line between the DSLAM 650c and the ADSL router/STB 630C. The term “xDSL” is a generic name of Asymmetric DSL (Digital subscriber Line), High-bit-rate DSL, Rate-Adaptive DSL, Symmetric DSL, Very-high-bit-rate DSL, and so on. Furthermore, the ATM (light, electricity) physical connection 501 is provided as a physical line between the ATM router/STB 630c and the subscriber terminal 640c. In this case, the DSLAM 650c and the ADSL router/STB 630c are provided as devices that make up the ATM subscriber network.

The network management device 24 shown in FIG. 19 or FIG. 24 is provided as the Network Management System (NMS) 610 and connected with the ATM router/STB 630c having the system of the third (2nd example) or sixth embodiment. The process shown in FIG. 16 is performed by the subscriber terminal 640c having the system shown in FIG. 15. The process indicated in FIG. 20 or FIG. 16 is executed on the ATM router/STB 630c. The ADSL router/STB630c having the system of FIG. 24 performs the process of FIG. 25 to establish the SVC connection 510 on the ATM (light, electricity) physical connection 501 between the ATM network 601 and the DSLAM. The SVC connection 510 comprises the IP layer (network layer) connection 520. In addition, the TCP/UDP connection 530 is present in the IP layer (network) connection 520 to provide a connection logic configuration.

On the other hand, the SVC connection 510 is established on the ATM over xDSL connection 503 between the ADSL router/STB 630 having the system of FIG. 19 and FIG. 24 and the DSLAM 650c. The SVC connection 510 comprises the IP layer (network layer) connection 520. In addition, the TCP/UDP connection 530 is present in the IP layer (network) connection 520 to provide a connection logic configuration. Further, the SVC connection 510 is established on the ATM (light, electricity) between the ADSL router/STB 630C having the device of FIG. 19 or FIG. 24 and the subscriber terminal 64 having the device of the third embodiment (1st example). The IP layer (network layer) connection 520 is present in the SVC connection 510, while the TCP/UDP connection 530 is present in the IP layer (network layer)

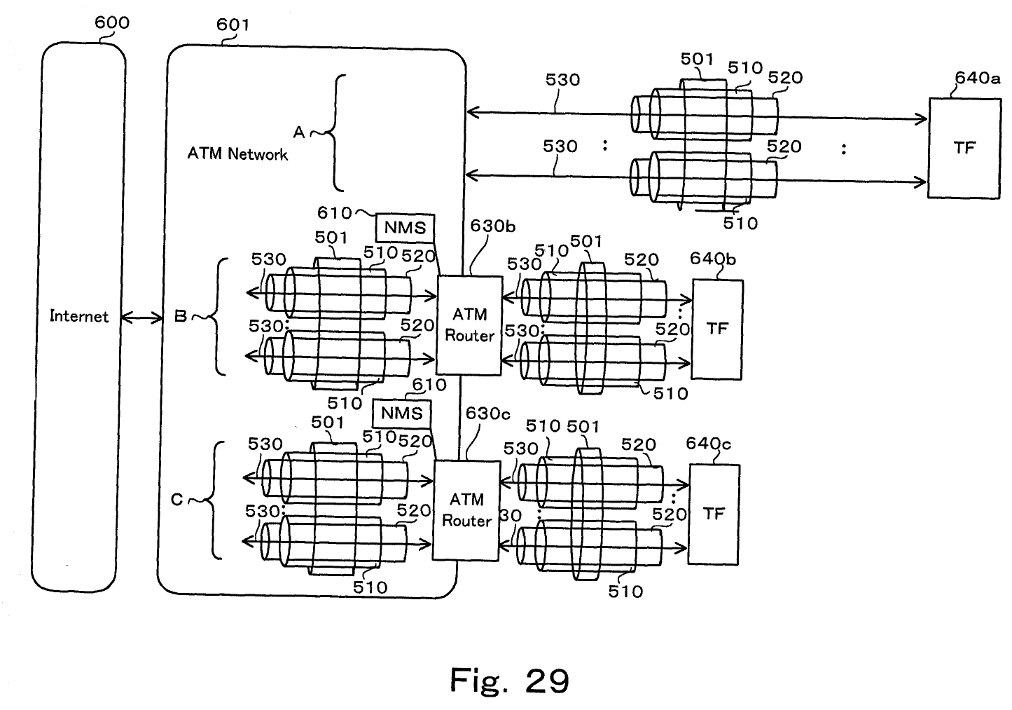

Next, a concrete third example will be described. FIG. 29 is a schematic diagram that illustrates the network configuration in accordance with a third preferred embodiment of the present invention. The portion indicated by the character “A” in FIG. 29 is a logic diagram that illustrates an example of IP over ATM, for example, the network comprising a subscriber' terminal having the system of the first or fourth embodiment, an ATM network, and the internet. More concretely, the portion “A” of FIG. 29 comprises the Internet 600, the ATM network 601, and the subscriber terminal 640a having the system of the first or fourth embodiment. The ATM (light, electricity) physical connection 501 is provided as a physical line between the ATM network 601 and the subscriber terminal 640a. The network management system 24 of FIG. 3 or FIG. 6 is provided as Network Management System (NMS) to be connected to the subscriber terminal 640a.

The SVC connection 510 can be established on the ATM (light, electricity) physical connection 501 between the ATM network 601 and the first or fourth embodiment of the present invention by executing the process shown in FIG. 22 at the subscriber terminal 640a having the system of FIG. 12 or the process shown in FIG. 9 at the subscriber terminal 640a having the system of FIG. 3. The connection logic configuration is that the IP layer (network layer) connection 520 is included in the SC connection 510 and the TCP/UDP connection 530 is included in the IP layer (network layer) connection 520.

The portion indicated by the character “B” in FIG. 29 is a logic diagram that illustrates an example of IP over ATM connection to be established, as an example, in the network to be constructed of the ATM router having the system of the second or fifth embodiment of the present invention, the subscriber terminal, the ATM network, and the Internet.

More concretely, the “B” portion of FIG. 29 comprises the Internet 600, the ATM network 601, the ATM router/STB 630b having the system of the second or fifth embodiment, and the subscriber terminal. In this case, furthermore, the Ether physical connection 502 is provided as a physical connection between the ATM router 630b and the subscriber terminal. The ATM router 630b of the second or fifth embodiment of the present invention may be connected to the network management device 502 of FIG. 14 or FIG. 26 as a Network Management System (NMS) 610.

The SVC connection 510 is established on the ATM (light, electricity) physical connection 501 between the ATM router 630b and the ATM network 601 by executing the process of FIG. 9 or FIG.22. The connection logic configuration is that the IP layer (network layer) connection 520 is included in the SVC connection 510 and the TCP/UDP connection is included in the IP layer (network layer) connection 520.

The connection logic configuration is that the conventional TCP/Ip connection 530 may be included in the Ether physical connection 502 between the ATM router/STB 630 having the system of the second or fifth embodiment and the subscriber terminal 640b.

The portion “C” of the FIG. 29 is a schematic diagram that illustrates an example of IP over ATM connection to be established in the network that is comprised of a subscriber terminal having the system of the third embodiment or the sixth embodiment, an ATM network, and the Internet. More concretely, the portion “C” of FIG. 9 comprises the ATM network 601, the ATM router 630cc having the system of the third embodiment (2nd example) or the sixth embodiment, and the subscriber terminal 640c having the third embodiment (1st example). The ATM router 630b is included in the ATM network 601 to provide a physical line of the ATM physical (light, electricity) connection 501 between the subscriber terminals.

The network management device 24 is provided as Network Management System) 610 and connected to the system of FIG. 24 through the network management device 24 of FIG. 19 or FIG. 24. The subscriber terminal 640c having the system shown in FIG. 15 executes the process shown in FIG. 16. The ATM router/STB 630c having the system shown in FIG. 19 executes the process shown in FIG. 16. The ATM router/STB 630c having the system shown in FIG. 24 executes the process shown in FIG. 25. Therefore, the SVC connection 510 is established on the ATM (light, electricity) physical connection 501 from the ATM router 630c to the ATM network 601. In this case, the connection logic configuration is that the IP layer (network layer) connection 520 is included in the SVC connection 510 and the TCP/UDP connection 530 is included in the IP layer (network layer) connection 520.

The SVC connection 510 is established on the ATM (light, electricity) physical connection 510 between the ATM router 630c having the system of FIG. 19 or FIG. 24 and the subscriber terminal 640c having the third preferred embodiment (1st example) of the present invention. In this case, the connection logic configuration is that the IP layer (network layer) connection 520 is included in the SVC connection 510 and the TCP/UDP connection 530 is included in the IP layer (network layer) connection 520.

According to the first to third embodiments of the present invention, in summary, the present invention can be adaptable various kinds of infrastructures for the ATM subscriber network. In addition, the present invention ensures the communication band and the communication quality of TCP or UDP/IP application and improves convenience and economic costs for subscribers to connect the ATM network or ATM subscriber network. Furthermore, the present invention allows the effective use of resources of the network.

The communication control system according to each of the embodiments of the present invention can be realized when a CPU of the system executes a communication control program stored in any recording medium such as a hard disk drive equipped in the system. The communication control program may be prepared so that it executes the process described in each embodiment described above.

The preferred embodiments of the present invention have been described and some of their advantages and effects will be described below.

A first advantage of the present invention is that the control of SVC connection can be performed so that the communication band and the communication quality are individually ensured on every service of TCP/IP application or UDP/IP application that provides data communication services on the Internet (e.g., e-mail, Web data, voice, still and motion pictures, and music data) because of the following reasons. That is, means for recognizing any service references the port number of header to be added by the TCP or UDP layer. Also, parameters such as Broadband Bearer Capability Information Elements (BBcap IEs) based on UNI 3.1 and UNI 4.0, ATM Traffic Descriptor Information Element (AtmTD IE), and so on are listed in tables. Thus, the parameters can be referenced using the table and incorporated so as to correspond to every recognized service to provide appropriate communication band information and communication-quality assurance information for establishing SVC connection.

Furthermore, another reason is to recognize each service using the port number of the header to be added by the TCP or UDP layer, where each port number corresponds to its specific service. The number may be previously registered from the predetermined numbers well known TCP or UDP port numbers such as IETE RFC1340 “Assigned Numers” (July 1992) (may be updated), or TCP or UDP numbers to be used in Voice over IP, Image over IP, or the like which have been available in recent years. Also, a reason is to recognize a Traffic Type required by a specific service by making a reference to Traffic Class (hereinafter, referred to as “TC”) to be added by IPv6 layer or Type of Service on the header to be added by IPv4 layer, by means of recognizing the traffic type. Another reason is to establish the SVC connection by making a matching table that represents the correspondence between the traffic types and the parameters of Quality of Service Parameter Information element (QoS IE) defined by UNI 3.1 or UNI 4.0, and setting communication quality information as a traffic type that individually corresponds to recognized service upon the Quality of Service Parameter Information of the SETUP message of the ATM UNI signaling message.

A second advantage of the present invention is to provide a SV connection having communication band and communication quality for each service of TCP/IP application or UDP/IP application to be provided by the data communication services over the Internet, using the standard of UNI 3.1 and UNI 4.0 because of the follows.

That is, the port number and the traffic type are defined for Broad band High Layer Information (BHLI) IE specified by UNI 3.1 or UNI 4.0, the port number of the header added by the TCP or UDP layer is referenced to the BHLI IE, the port number information detected by the means of recognizing the service is referenced to the Type of Service (ToS) of the header added by the IPv4 layer and Traffic Class of the header added by the IPv6 layer, and the Traffic Type required by the desired service is recognized and then the detected traffic type information is configured to the PHLI IE. In addition, another reason is that the BHLI IE having the port number information of the SETUP message of ATM signaling message and the traffic type information is processed between the local systems.

A third advantage of the present invention is to allow a centralized management of the ATM network or the ATM subscriber network without causing substantial decrease in the communication band and the communication quality for service. The reason is that the Network Management System (NMS) that keeps watch on the ATM network has tables corresponding to services and parameters of BBcap IEs, AtmTD IEs, traffic types, and QoS IEs, depending on UNI 3.1 or UNI 4.0; and setting the communication band and quality and udating the contents of the table depending on the conditions of the network if required and managing the parameters of information elements in the SETUP message for the ATM UNI signaling message.

A fourth aspect of the present invention is to provide a SVC connection for each of services of the TCP/IP application or UDP/IP application that provides Data communication services. The reason is that there is one-to-one correspondence between the connection management table and the SVC connection responsible for adapting TCP or UDP/application services and for ensuring the communication band and quality. Each SVC connection has several different markers because High-end TCP or UDP/IP applications are distinguished to provide TCP/UDP origin port address (reference numeral 74 in FIG. 11) and TCP/UDP terminal port number. Also, the SVC connection corresponds to both the destination IP address and the destination ATM address. Thus, if the SVC connection has already entered in the same TCP/UDP terminal port number, another origin port number can be registered by copying the TCP/UFP terminating port number, the destination IP address, and the destination ATM address are entered in another area of the connection management table.

A fifth advantage of the present invention is to keep appropriate requests for establishing the SVC connection for each service of TCP/IP application or UDP/IP application that provides data communication services without causing excessive request or insufficient request of the communication band and quality to the ATM network or the ATM subscriber network. The reason is that it is able to up data the definition information in the table that corresponds to the network management system (NMS) watching to the network, and information elements that corresponds to BBcap IE and AtmTD IE, traffic types. Furthermore, another table that defines traffic types and QoS IE may be used. The control unit 13 is able to inquire about the adaptability of data to the network management device 24 using those tables, when the SETUP message of ATM UNI signaling is constructed.

A sixth advantage of the present invention is to decrease in cost on the side of communication control system at the time of system installation. The reason is that the network management system (NMS) that keeps watch on the ATM network holds two tables. One table corresponds to BBcap IE and AtmTD IE defined by UNI 3.1 and UNI 4.0 and the other table corresponds to traffic types and QoS IEs. Thus, the communication control system does not require any memory area for storing such information.

A seventh advantage of the present invention is to provide the ATM network and the ATM subscriber network without causing significant decrease in the communication band and communication quality for providing services. The reason is that the network management system that makes watch on the ATM network holds two tables. One table corresponds to BBcap IE and AtmTD IE defined by UNI 3.1 and UNI 4.0 and the other table corresponds to traffic types and QoSIEs. The table manages parapeters of information elements for preparing a SETUP message of the a TM UNI signaling that defines the communication band and communication quality depending on the network.

The present invention has been described in detail with respect to preferred embodiments, and it will now be obvious to those skilled in the art that changes and modifications may be made without departing from the invention in its broader aspects, and it is the intention, therefore, in the appended claims to cover all such changes and modifications as fall within the true spirit of the invention.

Accordingly, the present invention produces the effects of, for example, recognizing and distinguishing the traffic types and the service types of the TCP/IP application or UDP/IP application and ensuring the communication band and communication quality depending on the recognized type.

What is claimed is:

1. A method for communication control, comprising the steps of:
recognizing service type information that specifies a type of communication service in a packet with a predetermined protocol;
obtaining parameter information for establishing connection, which is previously coordinate to the recognized service type information; and
sending a SETUP message that is generated using the obtained parameter information.

2. A method for communication control, wherein
the determined protocol is TCP or UDP; and
the service type information is a terminal port number in a TCP header or UDP header.

3. A method for communication control, comprising the steps of
recognizing traffic type information that specifies a traffic type in a packet with a predetermined protocol;
obtaining parameter information for establishing connection, which is previously coordinate to the recognized service type information; and
sending a SETUP message that is generated using the obtained parameter information.

4. A method for communication control as claimed in claim 3, wherein
the predetermined protocol is IP; and
the traffic type information is a service type or a traffic type in the IP header.

5. A communication control device, comprising:
means for recognizing service type information that specifies a type of communication service in a packet with a predetermined protocol;
means for obtaining parameter information that corresponds to the recognized service type information with reference to a table that defines a coordination between each service type information and a parameter information for establishing a connection; and
means for sending a SETUP message that is generated using the obtained parameter information.

6. A communication control device as claimed in claim 5, wherein
the determined protocol is TCP or UDP; and
the service type information is a terminal port number in a TCP header or UDP header.

7. A communication control device as claimed in claim 5 or 6, wherein the table is stored in a network management device external to the communication control device control, and parameter information defined in the table can be obtained by making an access to the network management device.

8. A communication control device, comprising:
means for recognizing traffic type information that specifies a type of traffic in a packet with a predetermined protocol;
means for obtaining parameter information that corresponds to the recognized traffic type information with reference to a table that defines a coordination between each traffic type information and a parameter information for establishing a connection; and
means for sending a SETUP message that is generated using the obtained parameter information.

9. A communication control device as claimed in claim 7, wherein
the determined protocol is an IP; and
the communication quality information is a service type or a traffic type in an IP header.

10. A communication control device as claimed in claim 8 or 9, wherein the table is stored in a network management device external to the communication control device control, and parameter information defined in the table can be obtained by making an access to the network management device.

11. A recording medium that stores a computer-readable communication control program for performing a communication control, wherein the communication control program is capable of executing the process comprising the steps of:
recognizing service type information that specifies a type of communication service in a packet with a predetermined protocol;
obtaining parameter information for establishing connection, which is previously coordinate to the recognized service type information; and
sending a SETUP message that is generated using the obtained parameter information.

12. A recording medium that stores a computer-readable communication control program for performing a communication control, wherein the communication control program is capable of executing the process comprising the steps of:
recognizing traffic type information that specifies a traffic type in a packet with a predetermined protocol;
obtaining parameter information for establishing connection, which is previously coordinate to the recognized service type information; and
sending a SETUP message that is generated using the obtained parameter information.

13. A method for communication control, comprising the steps of:
recognizing “Type of Service” as a traffic type when a predetermined protocol is IPv4 or recognizing “Traffic Class” as a traffic type when a predetermined protocol is IPv6;
recognizing a port number of TCP packet;
grasping information elements of SETUP message corresponding to the traffic type/the port number; and
sending the SETUP message to be generated using the grasped information elements.
